(19) United States
(12) Patent Application Publication
(10) Pub. No.: US 2020/0019022 A1
(43) Pub. Date: Jan. 16, 2020

(54) LIQUID CRYSTAL DISPLAY DEVICE, ALIGNMENT FILM FORMING MATERIAL, AND POLYMER COMPOUND

(71) Applicant: SHARP KABUSHIKI KAISHA, Sakai City, Osaka (JP)

(72) Inventors: KIMIAKI NAKAMURA, Sakai City, Osaka (JP); MASANOBU MIZUSAKI, Sakai City, Osaka (JP); TAKASHI KATAYAMA, Sakai City, Osaka (JP)

(21) Appl. No.: 16/498,232

(22) PCT Filed: Mar. 27, 2018
(86) PCT No.: PCT/JP2018/012530

§ 371 Date: Sep. 26, 2019

(30) Foreign Application Priority Data
Mar. 31, 2017 (JP) 2017-069987

(51) Int. Cl. G02F 1/1337; C08L 79/08

(52) U.S. Cl. CPC G02F 1/133723; C08L 2203/20; C08L 79/08

(57) ABSTRACT

A liquid crystal display device (100) includes a pair of substrates (11, 21), a liquid crystal layer (30) sandwiched between the pair of substrates (11, 21), an alignment film (12) disposed between the liquid crystal layer (30) and at least one substrate (11), and an alignment-sustaining layer (40) disposed between the alignment film (12) and the liquid crystal layer (30) and regulating the tilt direction of at least liquid crystal molecules close to the alignment film (12) among the liquid crystal molecules constituting the liquid crystal layer (30). The alignment film (12) contains a polymer compound having a functional group represented by the following Formula (1):

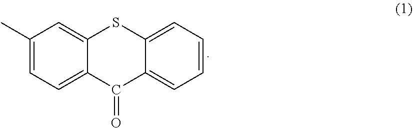 [SMILES: Cc1ccc2c(=O)c3ccccc3sc2c1]

### TECHNICAL FIELD

Some aspects of the present invention relate to a liquid crystal display device, an alignment film-forming material, and a polymer compound.

The present application claims priority from Japanese Patent Application No. 2017-069987, filed Mar. 31, 2017, the disclosure of which is hereby incorporated by reference herein in its entirety.

### BACKGROUND ART

A liquid crystal display device includes a pair of substrates and a liquid crystal layer disposed therebetween, and performs display by utilizing that the alignment direction of liquid crystal molecules changes depending on the voltage applied to a liquid crystal layer. The alignment direction (pretilt direction) of liquid crystal molecules in the state in which no voltage is applied to the liquid crystal layer has hitherto been regulated by an alignment film. For example, in a liquid crystal display device of a TN mode, the pretilt azimuth of liquid crystal molecules is regulated by applying rubbing treatment to a horizontal alignment film. Here, the term “pretilt azimuth” refers to a vector component in a liquid crystal layer plane (in a substrate plane) among vectors indicating the alignment direction of liquid crystal molecules in the liquid crystal layer not applied with a voltage. The pretilt angle formed by an alignment film and liquid crystal molecules is mainly determined by the combination of the alignment film and the liquid crystal material. The pretilt direction is expressed by a pretilt azimuth and a pretilt angle.

In recent years, as technology for controlling the pretilt direction of liquid crystal molecules, Polymer Sustained Alignment Technology (hereinafter, referred to as “PSA technology”) has been developed (e.g., PTL 1). The PSA technology is a technique that controls the pretilt direction of liquid crystal molecules by encapsulating a liquid crystal material containing a small amount of a polymerizable compound (typically, a photopolymerizable monomer) in a liquid crystal panel and then polymerizing the monomer to form an alignment-sustaining layer made of the polymer between a liquid crystal layer and an alignment film.

The alignment state of liquid crystal molecules when a polymer is generated can be retained (stored) even after elimination of the voltage (in the state of applying no voltage) by using the PSA technology. Accordingly, the PSA technology has an advantage that the pretilt azimuth and the pretilt angle of liquid crystal molecules can be adjusted by controlling, for example, the electric field formed in the liquid crystal layer. In addition, the PSA technology does not require rubbing treatment and is therefore suitable for, in particular, forming a vertical alignment type liquid crystal layer which is difficult to control the pretilt direction by rubbing treatment.

PTL 1 proposes technology for aligning liquid crystal molecules by adding one or both of a monomer and a polymerization initiator to an alignment film, letting one or both of the monomer and the polymerization initiator flow into a liquid crystal layer, and polymerizing the monomer in the liquid crystal layer.

In addition, in recent years, not only in liquid crystal display devices using the above-described TN mode vertical alignment type liquid crystal layer, but also in liquid crystal display devices of a horizontal field mode, such as an IPS (In-Plane Switching) mode and an FFS (Fringe Field Switching) mode, the PSA technology can combine an alignment-sustaining layer made of a polymer of a photopolymerizable monomer and a horizontal alignment film for forming a horizontal alignment type liquid crystal layer (PTL 2).

PTL 2 proposes a technique for enhancing the adhesion between an alignment film and an alignment-sustaining layer by adding a monomer into an alignment film material or by introducing an acrylate group or a methacrylate group into an alignment film-forming polymer compound itself.

### CITATION LIST

### Patent Literature

PTL 1: Japanese Unexamined Patent Application Publication No. 2004-286984

PTL 2: International Publication No. WO 2013/115130

### SUMMARY OF INVENTION

### Technical Problem

However, in the technique disclosed in PTL 1, the monomer in the liquid crystal layer polymerizes in the liquid crystal layer, and the polymer partially becomes huge (becoming a mass of several hundred nanometer size) to form a network-like polymer in the liquid crystal layer, resulting in an increase in image sticking and a decrease in contrast. It is inferred that the formation of polymer mass of a huge size is caused by that the polymerization starts from the monomer itself in the liquid crystal layer. That is, a part of the monomer in the liquid crystal layer generates radicals, the radical-generating monomer serves as the starting point of polymerization, and the molecular weight is increased by the subsequent growth reaction, resulting in phase separation. It is inferred that the phase-separated polymer is not uniformly distributed on an alignment film and is gathered near the already phase-separated polymer to make the polymer huge.

In addition, it is inferred that when a low-molecular-weight polymerization initiator is merely added to an alignment film, the polymerization initiator elutes in the liquid crystal layer, which decreases the VHR (Voltage Holding ratio) of the liquid crystal display device with generation of radicals after a durability test and increases residual Direct Current (rDC) to make image sticking and deterioration in image quality such as staining manifested.

In the technique disclosed in PTL 2, since the acrylate group and the methacrylate group in the alignment film or on the surface of the alignment film have low probabilities of becoming radicals, the polymerization reaction thereof is slow. In addition, it is inferred that the monomer remains in the liquid crystal layer even if the amount thereof is lower than the detection limit in chemical analysis, and image sticking occurs with a change in tilt angle during the use of the liquid crystal display device.

One aspect of the present invention has been made in view of such circumferences, and the object thereof is to provide a liquid crystal display device that includes an alignment-sustaining layer controlling the pretilt direction of liquid crystal molecules and an alignment film and has excellent image quality by reducing a decrease in VHR and an increase in residual DC, improving the amount of change in the tilt angle, and suppressing a reduction in contrast.

In addition, the object of one aspect of the present invention is to provide an alignment film-forming material that can realize such a liquid crystal display device, a polymer compound to be used in the alignment film, and a method for manufacturing the liquid crystal display device.

### Solution to Problem

The present inventors have intensively studied and as a result, have found that when an alignment film material contains a polymer compound having a covalently bonded functional group having a thioxanthone group, the monomer in a liquid crystal layer rapidly polymerizes on the surface of the alignment film, the monomer can hardly remain in the liquid crystal layer, and as a result, the VHR, residual DC, and tilt angle change amount (A tilt) are improved, and accomplished some aspects of the present invention.

That is, one aspect of the present invention provides a liquid crystal display device including a pair of substrates, a liquid crystal layer sandwiched between the pair of substrates, an alignment film disposed between the liquid crystal layer and at least one substrate of the pair of substrates, and an alignment-sustaining layer provided between the alignment film and the liquid crystal layer and regulating the tilt direction of at least liquid crystal molecules close to the alignment film among the liquid crystal molecules constituting the liquid crystal layer, wherein the alignment film contains a polymer compound having a functional group represented by the following Formula (1):

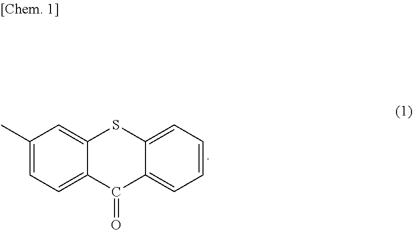 [SMILES: Cc1ccc2c(=O)c3ccccc3sc2c1]

In one aspect of the present invention, the polymer compound may have a covalently bonded functional group represented by the following Formula (2):

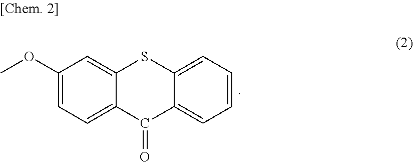 [SMILES: COc1ccc2c(=O)c3ccccc3sc2c1]

In one aspect of the present invention, the polymer compound may have a covalently bonded divalent functional group represented by the following Formula (3):

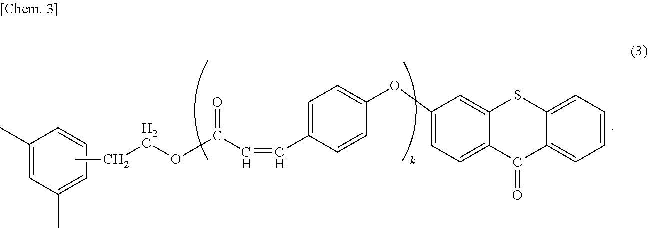

In one aspect of the present invention, the polymer compound may have a covalently bonded divalent functional group represented by the following Formula (4):

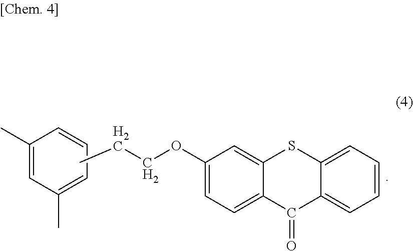

In one aspect of the present invention, the alignment film may contain a polymer compound having a covalently bonded functional group represented by the following Formula (5):

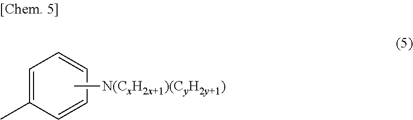

(x represents an integer of 1 to 4, and y represents an integer of 1 to 4).

In one aspect of the present invention, the alignment film may be made of a polyimide, a polyamic acid, or a polysiloxane.

In one aspect of the present invention, the alignment film may contain a polymer compound having a covalently bonded photoreactive functional group.

In one aspect of the present invention, the photoreactive functional group may be a group having a cinnamate group, a chalcone group, a coumarin group, an azobenzene group, or a tolan group.

In one aspect of the present invention, the alignment film may be made of a polyamic acid having a structural unit represented by the following Formula (6) or a polyimide having a structural unit represented by the following Formula (7):

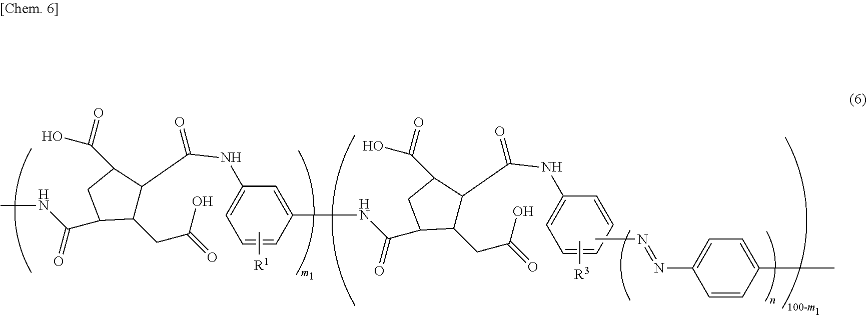

(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group),

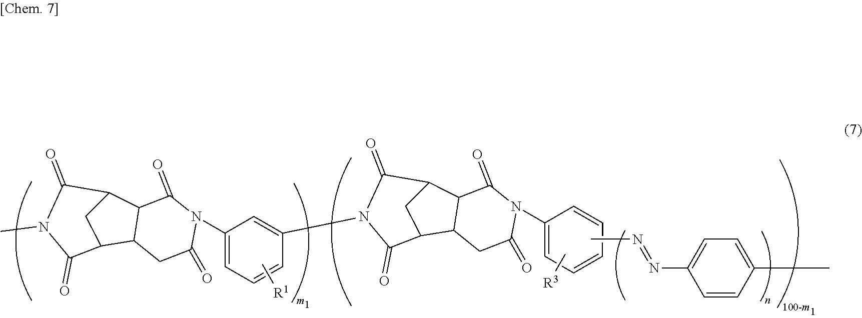

(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group),

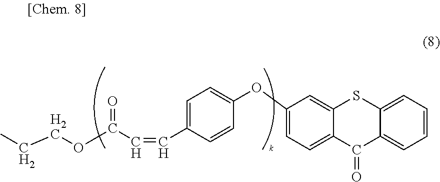

(k represents an integer of 0 to 3),

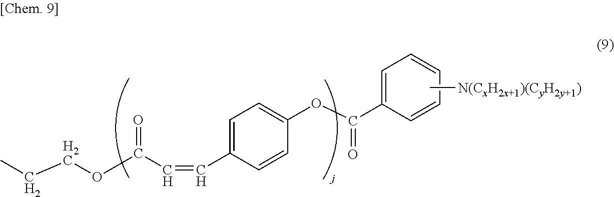

(j represents an integer of 0 to 3, x represents an integer of 1 to 4, and y represents an integer of 1 to 4).

In one aspect of the present invention, the alignment-sustaining layer may be formed by radical polymerization of a radical polymerizable monomer.

One aspect of the present invention provides an alignment film-forming material containing a polymer compound having a covalently bonded functional group represented by the following Formula (1):

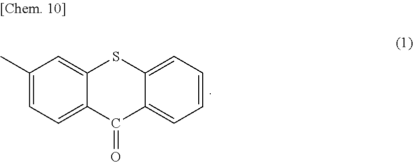 [SMILES: Cc1ccc2c(=O)c3ccccc3sc2c1]

Another aspect of the present invention provides a polyamic acid having a structural unit represented by the following Formula (6):

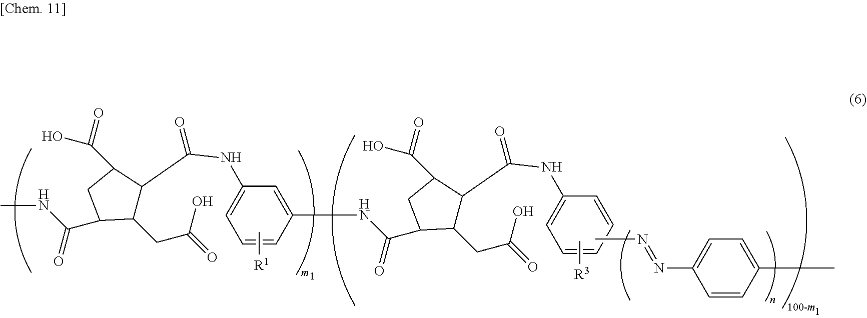

(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group),

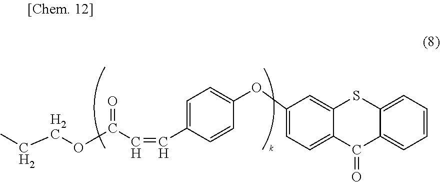

(k represents an integer of 0 to 3),

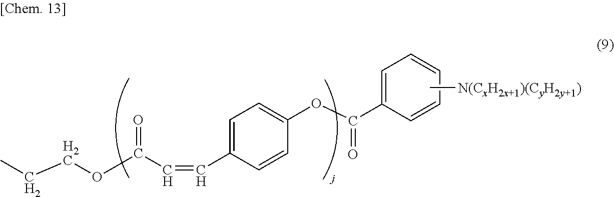

(j represents an integer of 0 to 3, x represents an integer of 1 to 4, and y represents an integer of 1 to 4).

Another aspect of the present invention provides a polyimide having a structural unit represented by the following Formula (7):

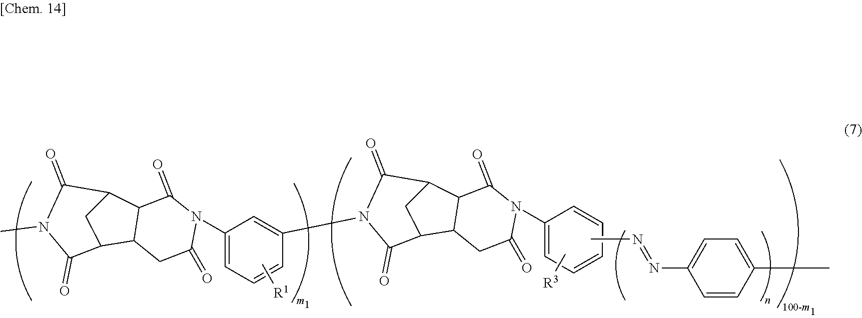

(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group),

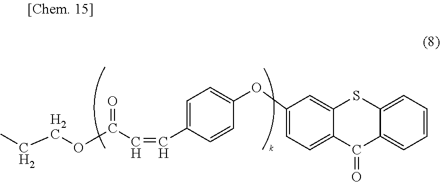

(k represents an integer of 0 to 3),

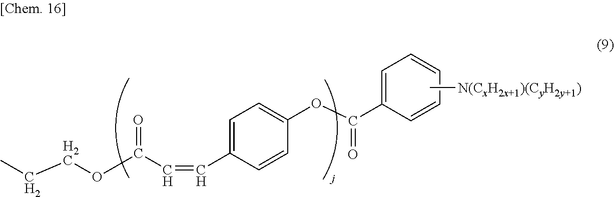

(j represents an integer of 0 to 3, x represents an integer of 1 to 4, and y represents an integer of 1 to 4).

Another aspect of the present invention provides a method for manufacturing a liquid crystal display device by forming a film from an alignment film-forming material containing a polymer compound having a functional group represented by the following Formula (1) on a substrate, subjecting the film formed from the forming material to alignment treatment to form an alignment film on the substrate, injecting a liquid crystal material containing a monomer between the alignment film and a counter substrate to form a liquid crystal layer, and then polymerizing the monomer to form an alignment-sustaining layer between the alignment film and the liquid crystal layer, where the alignment-sustaining layer regulates the tilt direction of at least liquid crystal molecules close to the alignment film among the liquid crystal molecules constituting the liquid crystal layer.

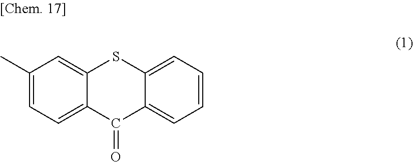 [SMILES: Cc1ccc2c(=O)c3ccccc3sc2c1]

### Advantageous Effects of Invention

In the liquid crystal display device according to an aspect of the present invention, when an alignment-sustaining layer is formed, an alignment film material that contains a polymer compound having a functional group having a thioxanthone group is used. Consequently, the monomer in the liquid crystal layer promptly polymerizes on the surface of the alignment film, the monomer can hardly remain in the liquid crystal layer, a decrease in VHR and an increase in residual DC are reduced, the amount of change in the tilt angle is improved, and a reduction in contrast is suppressed to provide excellent image quality.

Some aspects of the present invention can provide an alignment film that enables a liquid crystal display device to have excellent image quality, a new polymer compound to be used in the alignment film, and a method for manufacturing the liquid crystal display device.

### BRIEF DESCRIPTION OF DRAWINGS

FIG. 1 shows an example of a liquid crystal display device according to an aspect of the present invention.

### DESCRIPTION OF EMBODIMENTS

A liquid crystal display device according to a First Embodiment of the present invention will now be described with reference to the drawing. In the following drawing, the dimensions and ratios of each component are appropriately changed for convenience of reference.

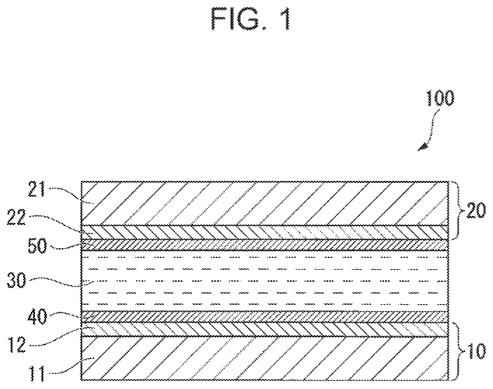

FIG. 1 is a cross-sectional view schematically illustrating a liquid crystal display device of the embodiment. As shown in FIG. 1, the liquid crystal display device 100 of the embodiment includes a pair of substrates 11, 21; a liquid crystal layer 30 sandwiched between the pair of substrates 11, 21; an alignment film 12 disposed between the liquid crystal layer 30 and at least one substrate 11; and an alignment-sustaining layer 40 provided between the alignment film 12 and the liquid crystal layer 30 and regulating the tilt direction of at least liquid crystal molecules close to the alignment film 12 among the liquid crystal molecules constituting the liquid crystal layer 30. The liquid crystal display device 100 of the embodiment adopts a device configuration of a VA (Vertical Alignment) system ECB mode. The display system of the liquid crystal display device is not particularly limited. As the display system, various known display systems, such as IPS (In-Plane Switching) system, FFS (Fringe-Field Switching) system, OCB (Optically Compensated Bend) system, and TN (Twisted Nematic) system, can be adopted.

### [Element Substrate]

The element substrate 10 includes one substrate 11 being a TFT substrate, an alignment film 12 provided on the liquid crystal layer 30 side of the substrate 11, and a first polarizing plate 19 (not shown) provided on the opposite side of the substrate 11 from the liquid crystal layer 30. In addition, an alignment-sustaining layer 40 is provided on the surface of the alignment film 12 so as to be in contact with the alignment film 12. The polarizing plate 19 can have a usually known configuration.

The TFT substrate includes a driving TFT element (not shown). The drain electrode, the gate electrode, and the source electrode of the driving TFT element are electrically connected to a pixel electrode, a gate bus line, and a source bus line, respectively. Each pixel is electrically connected via the electric wiring of the source bus line and the gate bus line.

The materials for forming each member of the TFT substrate can be usually known materials. The material of the semiconductor layer of the driving TFT is preferably IGZO (quaternary mixed crystal semiconductor material containing indium (In), gallium (Ga), zinc (Zn), and oxygen (O)). When IGZO is used as a material for forming a semiconductor layer, since the off-leakage current is low in the resulting semiconductor layer, charge leakage is suppressed. Consequently, the idle period after application of voltage to the liquid crystal layer can be elongated. As a result, the number of times of voltage application during the image display period can be decreased, and the power consumption of the liquid crystal display device can be decreased.

In the liquid crystal display device, the TFT substrate may be an active matrix system in which each pixel includes a driving TFT or a simple matrix system in which each pixel does not include a driving TFT.

### [Alignment Film]

The alignment film 12 has a function of giving an alignment regulating force to the liquid crystal material being contact with the surface thereof. The alignment film 12 may be a vertical alignment film, a horizontal alignment film, or a photo-alignment film that gives a pretilt angle to the liquid crystal material. In the photo-alignment film, the alignment film-forming material has a photoreactive functional group and is provided with alignment regulating force by light irradiation.

The material for forming the alignment film 12 contains a polymer compound having a functional group represented by the following Formula (1):

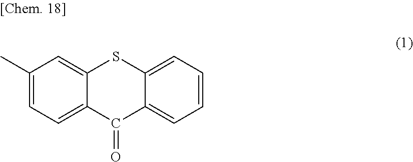 [SMILES: Cc1ccc2c(=O)c3ccccc3sc2c1]

Since the thioxanthone group represented by Formula (1) absorbs long-wavelength light up to approximately 420 nm, can generate radicals, and has a triplet excitation state, the radical is stable. That is, the thioxanthone group represented by Formula (1) has a radical polymerization-initiating function.

Since the material for forming the alignment film 12 contains a thioxanthone group represented by Formula (1), when the monomer contained in the liquid crystal material is polymerized, the thioxanthone group represented by Formula (1) functions as a polymerization initiator (polymerization initiating group) on the surface of the alignment film 12, and the polymerization starting point of the monomer in the liquid crystal material can be uniformly distributed on the surface of the alignment film 12. As a result, an alignment-sustaining layer 40 made of a homogeneous polymer can be formed on the surface of the alignment film 12 with uniform adhesion, and the polymer in the liquid crystal layer can be prevented from becoming huge. In the liquid crystal display device 100, the alignment behavior of the liquid crystal in the liquid crystal layer can be easily controlled, and an increase in image sticking and a decrease in contrast can be prevented.

In addition, it is inferred that since the material for forming the alignment film 12 contains a thioxanthone group represented by Formula (1), the rate constant of the polymerization initiation reaction is improved to complete the polymerization in a short period of time, the residual monomer in the liquid crystal layer can be substantially eliminated, and in the liquid crystal display device 100, the amount of change in the tilt angle is improved, and a reduction in contrast is suppressed to contribute to improvement of image quality.

The polymer compound may have a functional group represented by the following Formula (2):

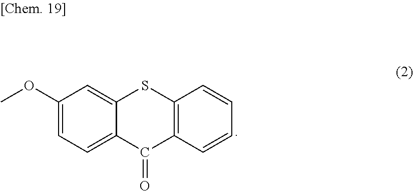 [SMILES: COc1ccc2c(=O)c3ccccc3sc2c1]

The polymer compound may have a divalent functional group represented by the following Formula (3):

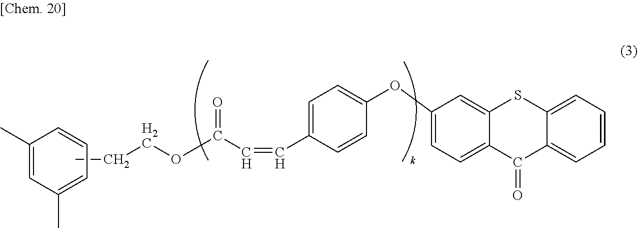

(k represents an integer of 0 to 3).

The polymer compound may have a divalent functional group represented by the following Formula (4):

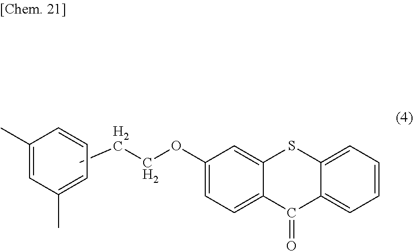

The alignment film-forming material may contain a polymer compound having a functional group represented by the following Formula (5):

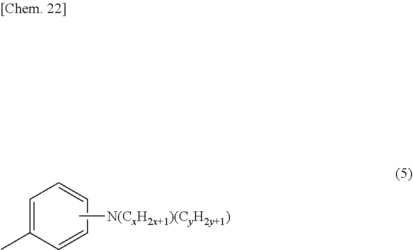

(x represents an integer of 1 to 4, and y represents an integer of 1 to 4).

The tertiary amino group represented by Formula (5) shows a radical polymerization-initiating function, together with a thioxanthone group represented by Formula (1).

The material for forming the alignment film 12 contains a polymer compound having both functional groups, a thioxanthone group and a tertiary amino group, and thereby absorbs long-wavelength light up to approximately 420 nm as shown in the following expression. The thioxanthone group can easily extract hydrogen from the tertiary amino group, the generated radicals can be uniformly distributed on the surface of the alignment film 12, and in the polymerization of the monomer in the liquid crystal material, the radical polymerization starting point can be uniformly distributed on the surface of the alignment film 12.

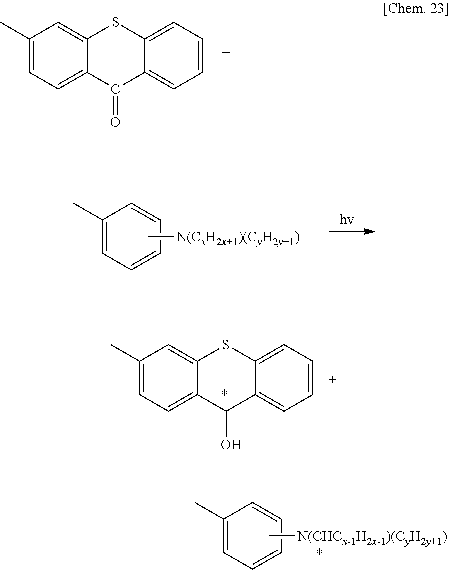

In one aspect of the present invention, the alignment film-forming material may contain a polymer compound having a photoreactive functional group.

The photoreactive functional group is a functional group that can regulate the alignment azimuth of liquid crystal molecules by irradiation with light.

In one aspect of the present invention, the photoreactive functional group may be a group having a cinnamate group, a chalcone group, a coumarin group, an azobenzene group, or a tolan group.

The photoreactive functional group may be included in a main chain skeleton of the alignment film-forming material or may be included in a side chain of the alignment film-forming material. The photoreactive functional group is preferably included in a side chain of the polymer compound, because it is easy to cause a photoreaction and it is possible to reduce the irradiation amount of light for causing the photoreaction. When the photoreactive functional group is included in a side chain skeleton of the polymer compound, the alignment film can be formed into a vertical alignment film; and when the photoreactive functional group is included in a main chain skeleton of the polymer compound, the alignment film can be formed into a horizontal alignment film, but these are not restrictive.

In one aspect of the present invention, the alignment film may be made of a polyimide, a polyamic acid, or a polysiloxane.

The polyimide for the alignment film can be obtained by using a polyamic acid as a precursor and performing intramolecular cyclization (imidization) of the polyamic acid.

### (Polyamic Acid and Polyimide)

Examples of the polyamic acid used in the alignment film-forming material and the polyamic acid as the precursor of the polyimide used as the alignment film-forming material include polyamic acids having structural units represented by the following Formula (61), where the polyamic acid skeletons include X units represented by the following Formulae (X-1) to (X-7), E units represented by the following Formulae (E-21) to (E-36), and Z units having functional groups represented by Formula (1). As the X unit, four bondable sites are shown. To the four bondable sites, two carbonyl groups that bond when introduced into the position of X in Formula (61) and two carboxy groups (not shown) bond. Multiple X units may be the same or different. Multiple E units may be the same or different. Multiple Z units may be the same or different.

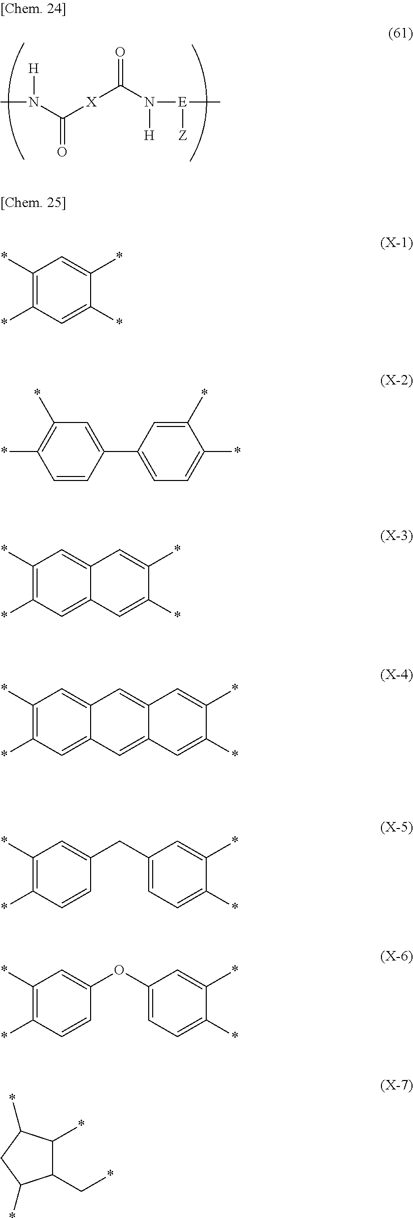

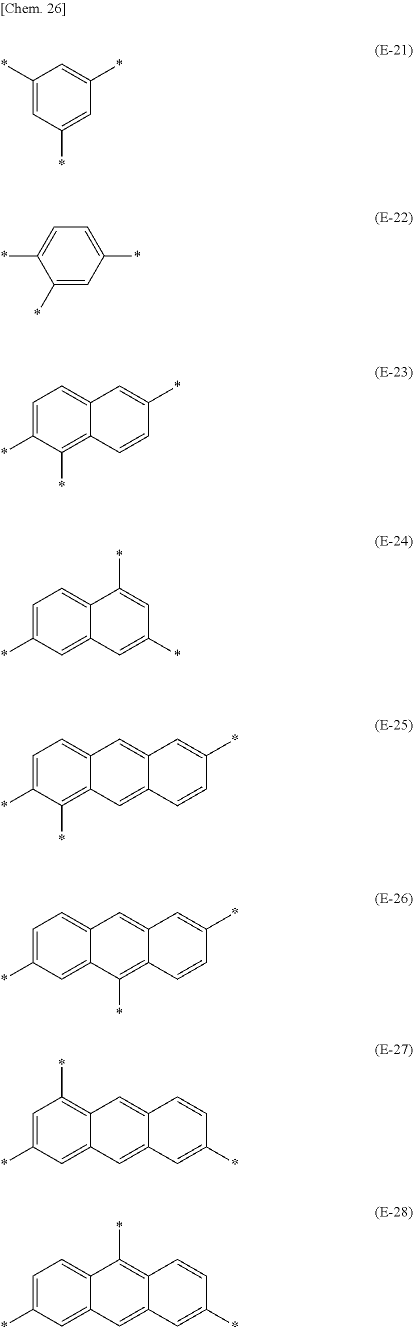

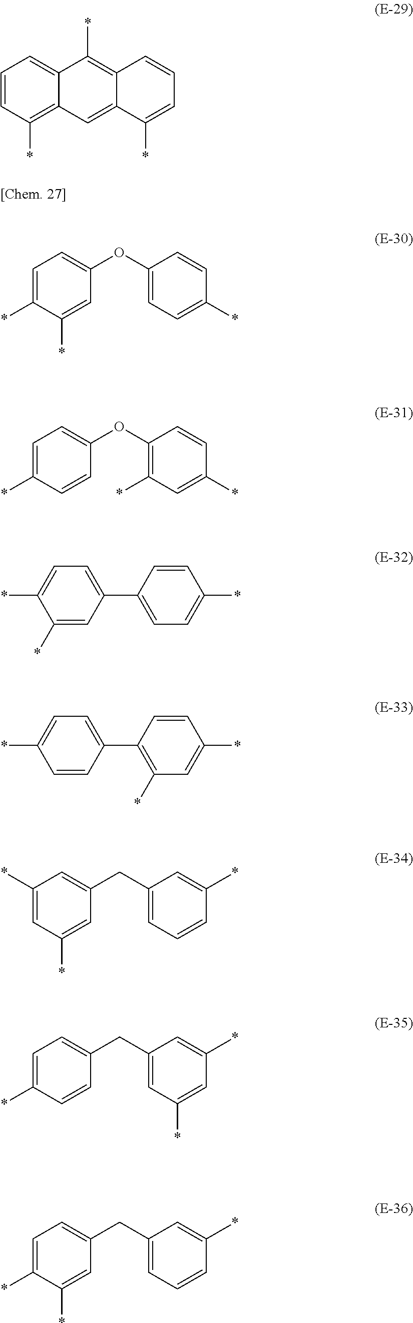

At least one of the multiple Z units included in the polyimide (polyamic acid) as the alignment film-forming material can be, for example, one represented by the following Formula (8):

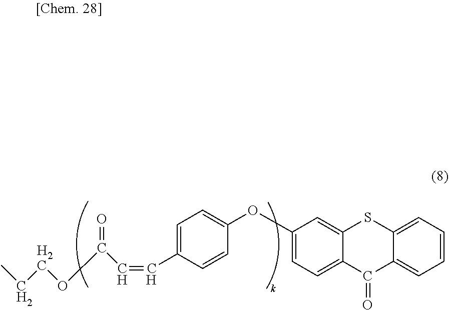

(k represents an integer of 0 to 3).

A method for synthesizing a monomer when k=1 as the monomer having a functional group represented by Formula (8) will be shown in Example described later, and the monomer is used in synthesis of random copolymers of Examples 1 to 5. Monomers having a functional group represented by Formula (8) when k=2 or 3 can also be synthesized in accordance with the method for synthesizing the monomer when k=1. A monomer when k=0 is used as the monomer having a functional group represented by Formula (8) in synthesis of random copolymers of Examples 11 to 15 described later.

At least one of the multiple Z units included in the polyimide (polyamic acid) as the alignment film-forming material may be one represented by the following Formula (9):

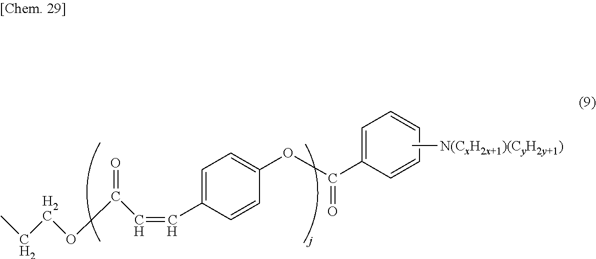

(j represents an integer of 0 to 3, x represents an integer of 1 to 4, and y represents an integer of 1 to 4).

A method for synthesizing a monomer when j=1, x=1, and y=1 as the monomer having a functional group represented by Formula (9) will be shown in Example described later, and the monomer is used in synthesis of random copolymers of Examples 1 to 5. Monomers having a functional group represented by Formula (9) when j=2 or 3 can also be synthesized in accordance with the method for synthesizing the monomer when j=1. A monomer when j=0, x=1, and y=1 is used as the monomer having a functional group represented by Formula (9) in synthesis of random copolymers of Examples 11 to 15 described later.

At least one of the multiple Z units included in the polyimide (polyamic acid) as the alignment film-forming material may be a photoreactive functional group, a vertically aligning group, a horizontally aligning group, or a combination thereof.

The vertically aligning group is a functional group in which liquid crystal molecules are aligned vertical to the substrate plane. The term “vertical alignment” refers to a case in which the average initial inclination angle of the liquid crystal molecules with respect to the substrate plane is 600 to 900, preferably 800 to 900. In addition, the horizontally aligning group is a functional group in which liquid crystal molecules are aligned horizontal to the substrate plane. The term “horizontal alignment” refers to a case in which the average initial inclination angle of the liquid crystal molecules with respect to the substrate plane is 0° to 30°, preferably 0° to 10°. The “inclination angle” is an angle formed by the major axis of a liquid crystal molecule and a substrate plane in a range of 0° to 90°, and the “average inclination angle” is also referred to as “tilt angle”. The average of inclination angles of liquid crystal molecules with respect to a substrate when no voltage is applied is referred to as “average initial inclination angle” and is also simply referred to as “pretilt angle” hereinafter.

When the liquid crystal display device according to an aspect of the present invention is applied to a liquid crystal display device including a vertical alignment film, at least one of the multiple Z units included in the polyimide (polyamic acid) as the vertical alignment film-forming material may be a vertically aligning group represented by any of the following Formulae (Z-201) to (Z-223).

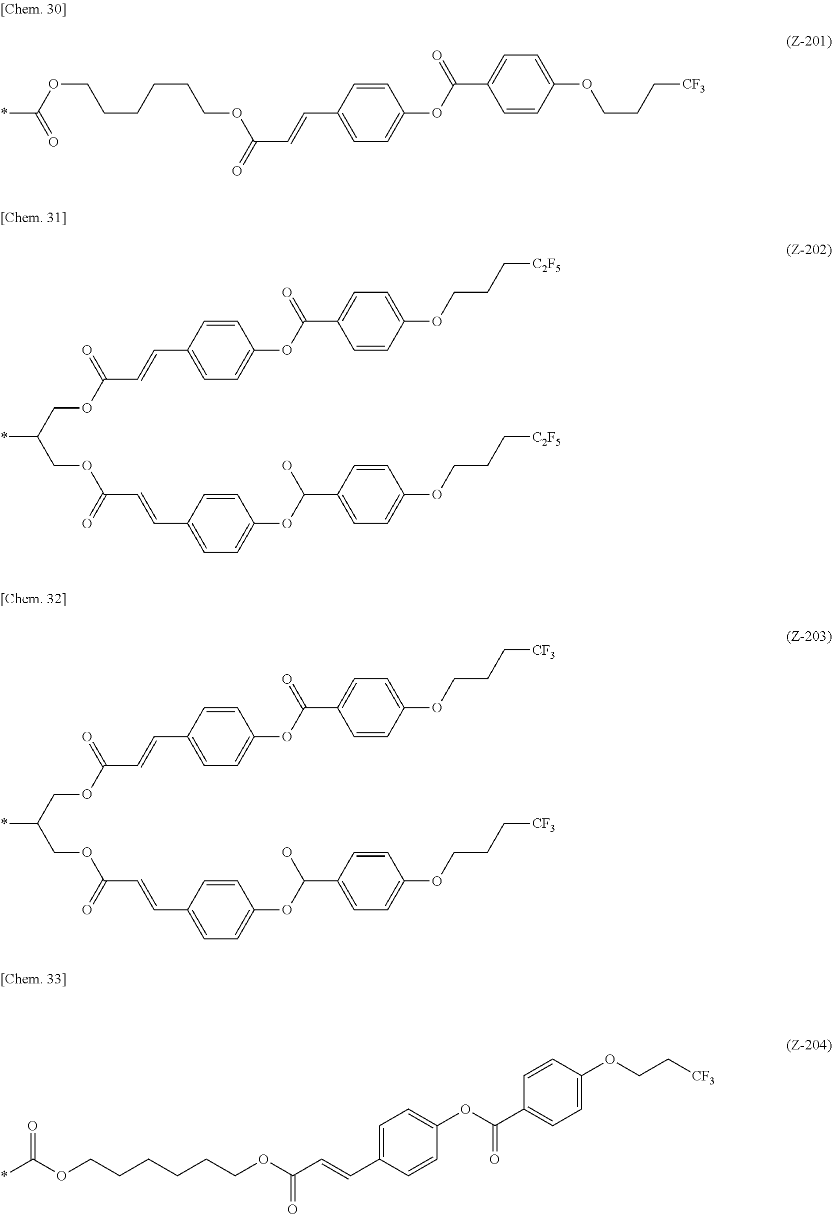

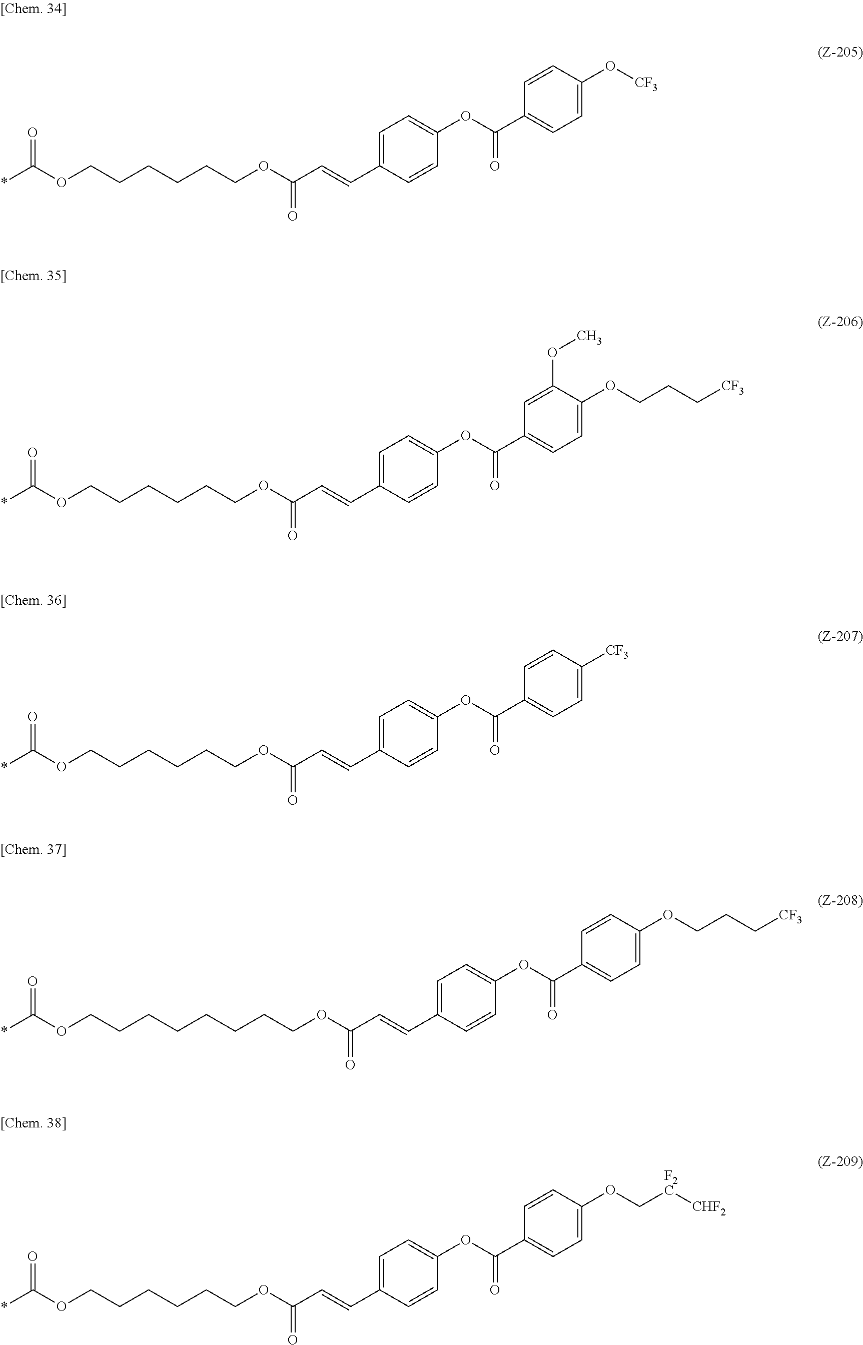 [SMILES: *C(=O)OCCCCCCOC(=O)/C=C/c1ccc(OC(=O)c2ccc(OC(F)(F)F)cc2)cc1 ; *C(=O)OCCCCCCOC(=O)/C=C/c1ccc(OC(=O)c2ccc(OCCCC(F)(F)F)c(OC)c2)cc1 ; *C(=O)OCCCCCCOC(=O)/C=C/c1ccc(OC(=O)c2ccc(C(F)(F)F)cc2)cc1 ; *C(=O)OCCCCCCCCOC(=O)/C=C/c1ccc(OC(=O)c2ccc(OCCCC(F)(F)F)cc2)cc1 ; *C(=O)OCCCCCCOC(=O)/C=C/c1ccc(OC(=O)c2ccc(OCC(F)(F)C(F)F)cc2)cc1]

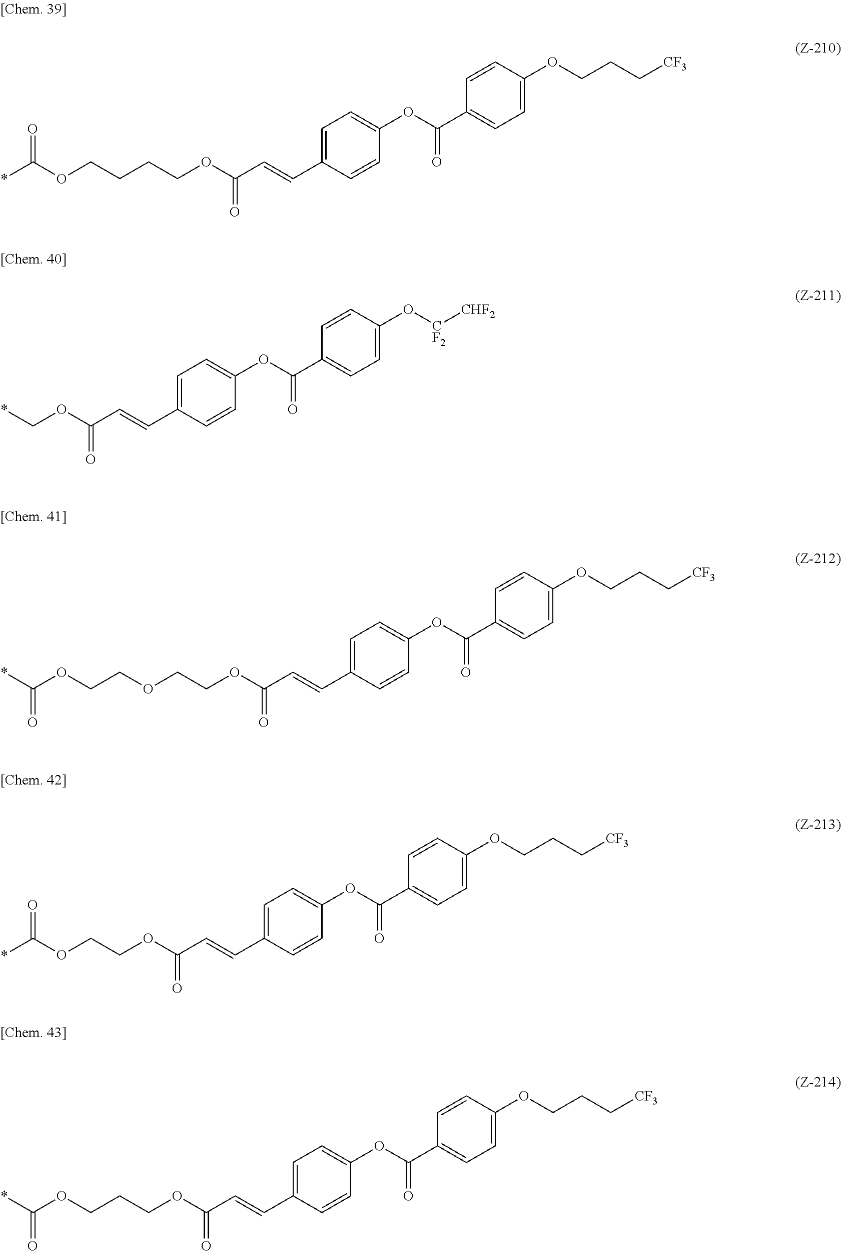 [SMILES: *C(=O)OCCCCOC(=O)/C=C/c1ccc(OC(=O)c2ccc(OCCCC(F)(F)F)cc2)cc1 ; *COC(=O)/C=C/c1ccc(OC(=O)c2ccc(OC(F)(F)C(F)F)cc2)cc1 ; *C(=O)OCCOCCOC(=O)/C=C/c1ccc(OC(=O)c2ccc(OCCCC(F)(F)F)cc2)cc1 ; *C(=O)OCCOC(=O)/C=C/c1ccc(OC(=O)c2ccc(OCCCC(F)(F)F)cc2)cc1 ; *C(=O)OCCCOC(=O)/C=C/c1ccc(OC(=O)c2ccc(OCCCC(F)(F)F)cc2)cc1]

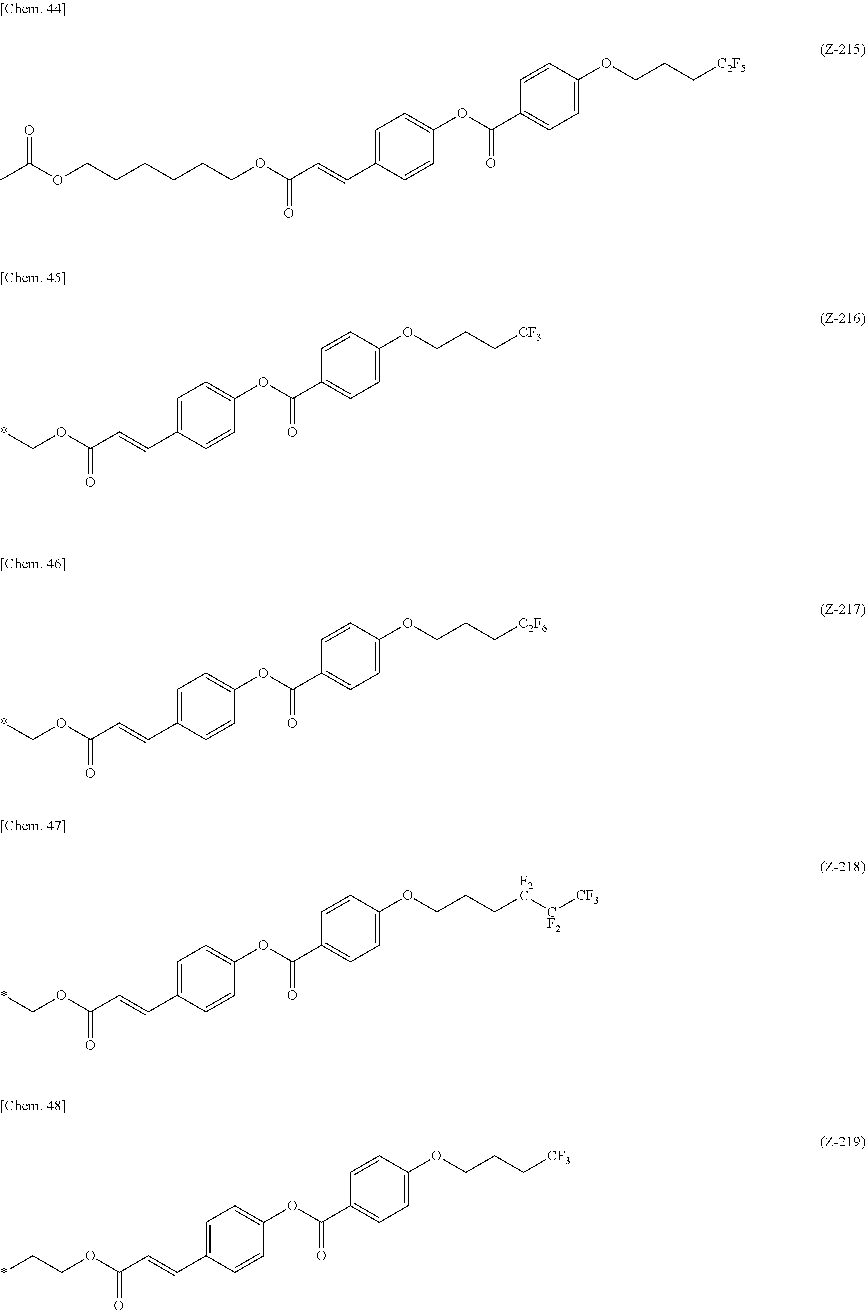

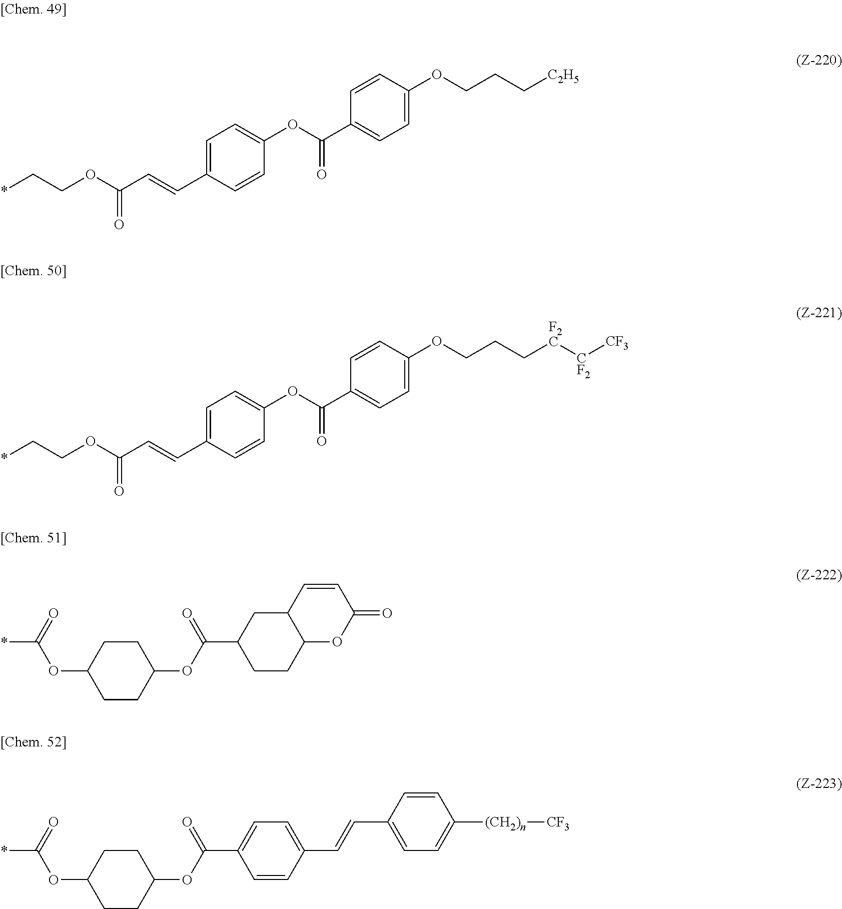

The vertically aligning groups represented by Formulae (Z-201) to (Z-221) are also photoreactive functional groups having cinnamate groups, the vertically aligning group represented by Formula (Z-222) is also a photoreactive functional group having a coumarin group, and the vertically aligning group represented by Formula (Z-223) is also a photoreactive functional group having a stilbene group.

At least one of the multiple Z units may be any of the following Formulae (Z-301) to (Z-307).

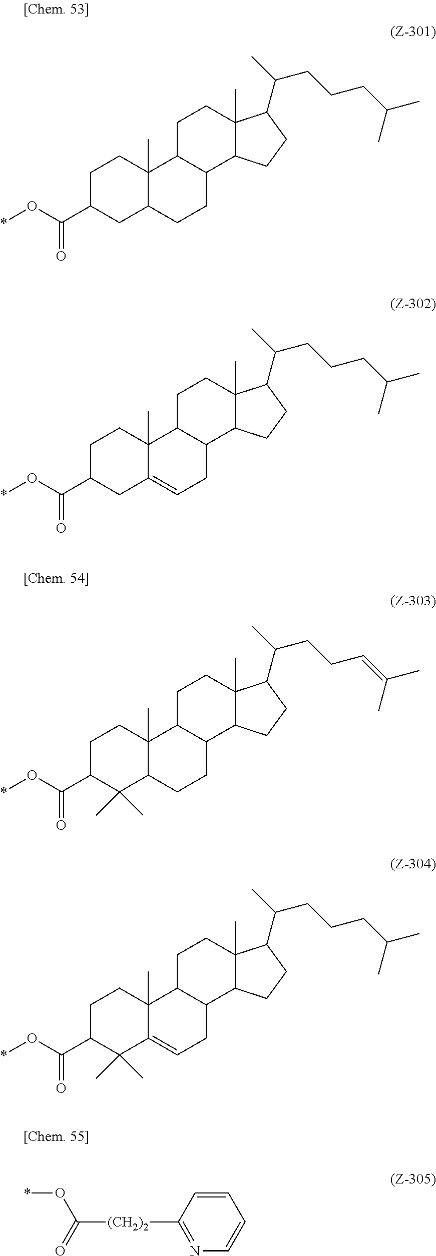

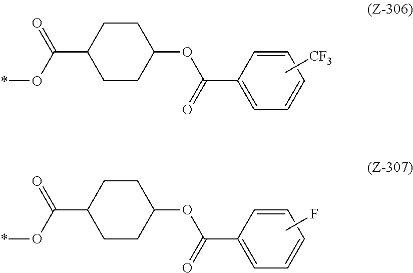

When the liquid crystal display device according to an aspect of the present invention is applied to a liquid crystal display device including a horizontal alignment film, at least one of the multiple Z units included in the polyimide (polyamic acid) as the horizontal alignment film-forming material may be a hydrogen atom, an alkyl group having 1 to 4 carbon atoms, a cycloalkyl group having 3 to 8 carbon atoms, or a horizontally aligning group of an aromatic group having 4 to 8 carbon atoms. In the alkyl group, the cycloalkyl group, and the aromatic group, one or more hydrogen atoms may be substituted with a fluorine atom or a chlorine atom.

At least one of the multiple Z units may be one having a photoreactive functional group. Examples of the photoreactive functional group include those represented by the following Formulae (Z-101) to (Z-106).

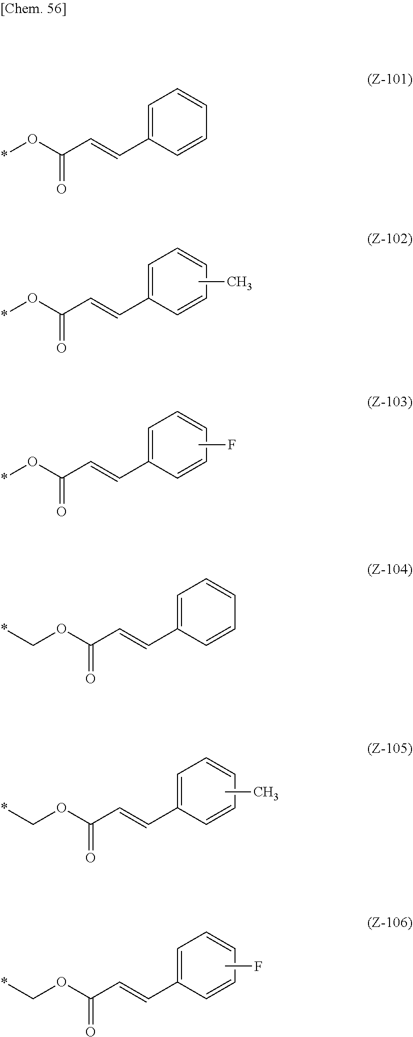

The polyamic acid used in the alignment film or the polyamic acid as the precursor of the polyimide used in the alignment film may be a polyamic acid having a structural unit represented by the following Formula (61), where the polyamic acid skeleton includes an X unit represented by any of Formulae (X-1) to (X-7), an E unit represented by any of the following Formulae (E-1) to (E-14), and either the X unit and the E unit may include a group having a photoreactive functional group. As the X unit, four bondable sites are shown. To the four bondable sites, two carbonyl groups that bond when introduced into the position of X in Formula (61) and two carboxy groups (not shown) bond. Examples of the photoreactive functional group that can be adopted in the X unit include those represented by the following Formulae (X-101) to (X-105), and examples of the photoreactive functional group that can be adopted in the E unit include those represented by the following Formulae (E-101) to (E-105). Multiple E units may be the same or different. Multiple Z units may be the same or different.

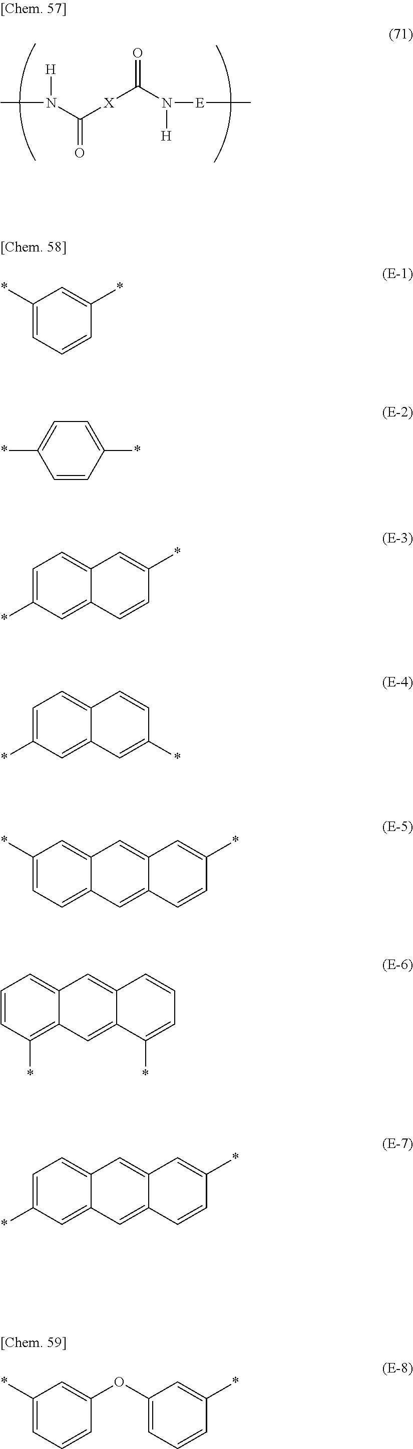

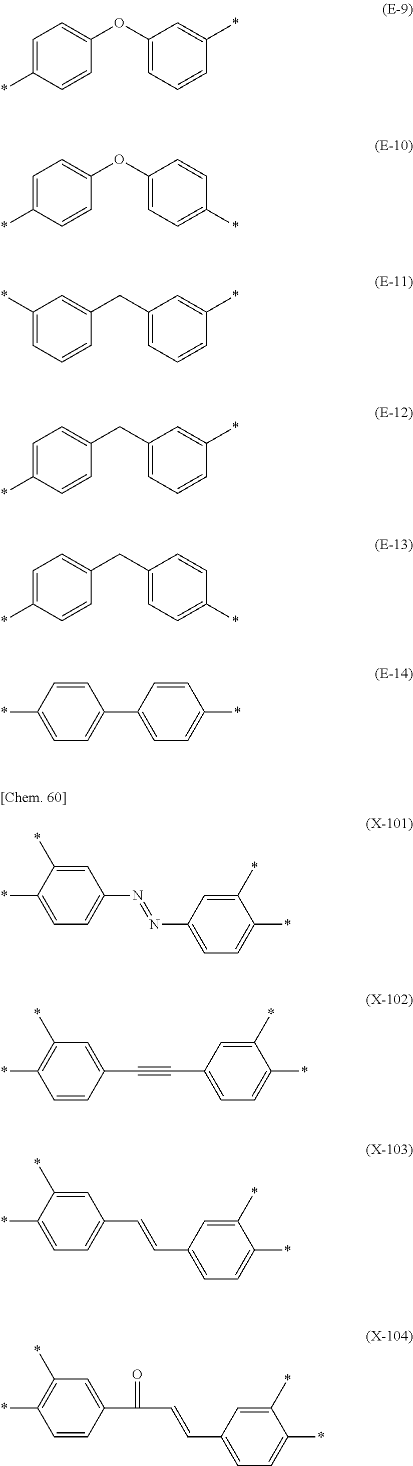

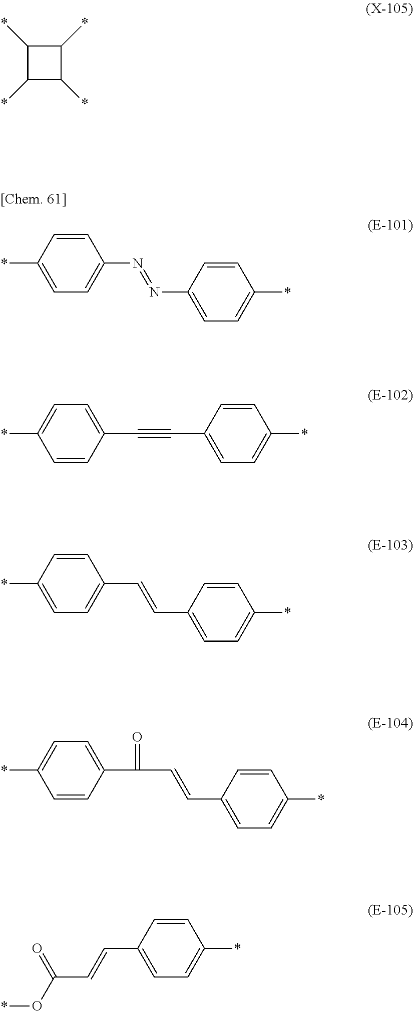 [SMILES: *C1C(*)C(*)C1* ; *c1ccc(/N=N/c2ccc(*)cc2)cc1 ; *c1ccc(C#Cc2ccc(*)cc2)cc1 ; *c1ccc(/C=C/c2ccc(*)cc2)cc1 ; *c1ccc(/C=C/C(=O)c2ccc(*)cc2)cc1 ; *OC(=O)/C=C/c1ccc(*)cc1]

The polyamic acid used in the alignment film or the polyamic acid as the precursor of the polyimide used in the alignment film may be a polyamic acid having a structural unit represented by the following Formula (6):

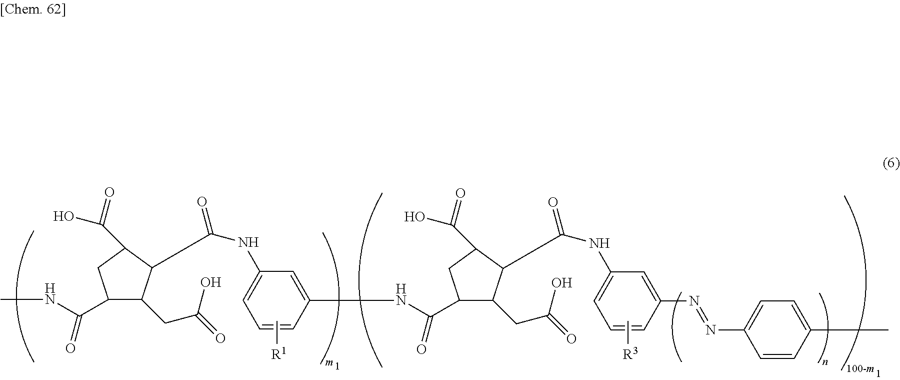

(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group),

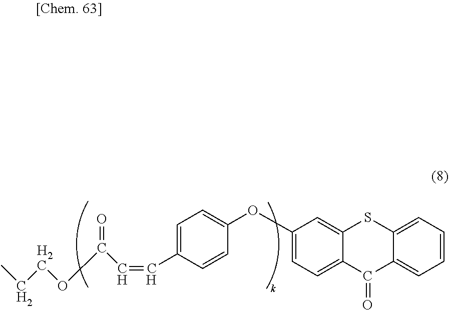

(k represents an integer of 0 to 3),

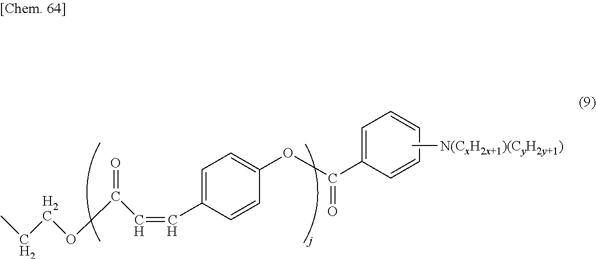

(j represents an integer of 0 to 3, x represents an integer of 1 to 4, and y represents an integer of 1 to 4).

Since the thioxanthone group in the functional group represented by Formula (8) absorbs long-wavelength light up to approximately 420 nm, can generate radicals, and has a triplet excitation state, the radical is stable. That is, the functional group represented by Formula (8) has a radical polymerization-initiating function.

In the polyamic acid having a structural unit represented by the following Formula (6), a part of the functional group represented by Formula (8) may be substituted with a functional group represented by Formula (9). In such a case, the thioxanthone group in the functional group represented by Formula (8) absorbs long-wavelength light up to approximately 420 nm and can easily extract hydrogen from the tertiary amino group in the functional group represented by Formula (9). Consequently, the generated radicals can be uniformly distributed on the surface of the alignment film 12, and the radical polymerization starting point can be uniformly distributed on the surface of the alignment film 12 in polymerization of the monomer in the liquid crystal material.

It is inferred that when the thioxanthone group in the functional group represented by Formula (8) extracts hydrogen, the functional group represented by Formula (8) changes into a radical represented by the following Formula (8-0):

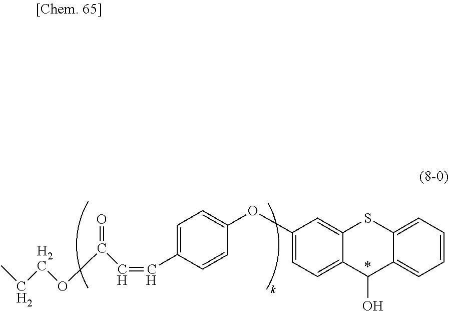

(k represents an integer of 0 to 3).

It is inferred that the thioxanthone group in the functional group represented by Formula (8) extracts hydrogen from the tertiary amino group in the functional group represented by Formula (9), the functional group represented by Formula (9) changes into a radical represented by the following Formula (9-0):

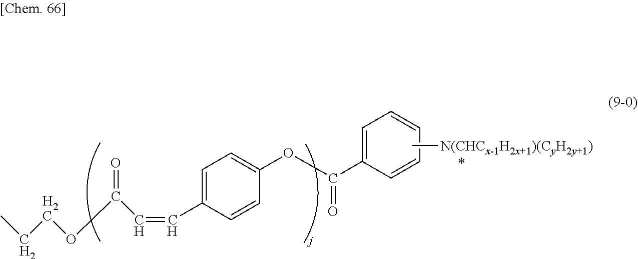

(j represents an integer of 0 to 3, x represents an integer of 1 to 4, and y represents an integer of 1 to 4).

The polyamic acid having a structural unit represented by Formula (6) as the polyamic acid used in the alignment film or the polyamic acid as the precursor of the polyimide used in the alignment film may be a random copolymer or may be a block copolymer. From the viewpoint of uniformly distributing the radical polymerization starting point on the surface of the alignment film 12, the polyamic acid having a structural unit represented by Formula (6) is preferably a random copolymer.

As the polyamic acid used in the alignment film or the polyamic acid as the precursor of the polyimide used in the alignment film, the polyamic acid having a structural unit represented by Formula (6), the polyamic acid having a structural unit represented by Formula (61), and the polyamic acid having a structural unit represented by Formula (71) may each have a weight-average molecular weight (Mw) within a range of 3,000 to 1,000,000 or within a range of 10,000 to 100,000 and a molecular weight distribution (Mw/Mn) within a range of 1 to 4 or within a range of 2 to 3.

The functional group represented by Formula (8) may be a functional group represented by the following Formula (8-1) or a functional group represented by the following Formula (8-2).

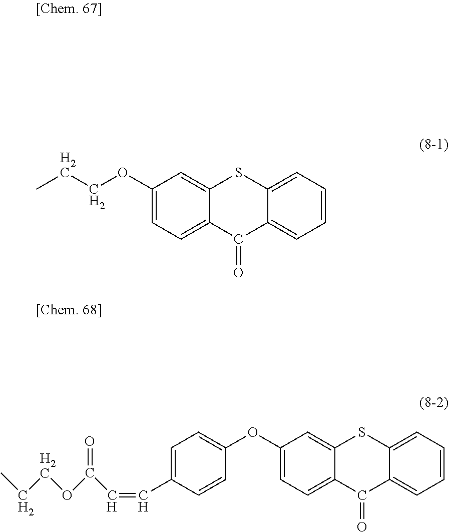 [SMILES: CCCOc1ccc2c(=O)c3ccccc3sc2c1 ; CCCOC(=O)/C=C\c1ccc(Oc2ccc3c(=O)c4ccccc4sc3c2)cc1]

The functional group represented by Formula (9) may be a functional group represented by the following Formula (9-1) or a functional group represented by the following Formula (9-2).

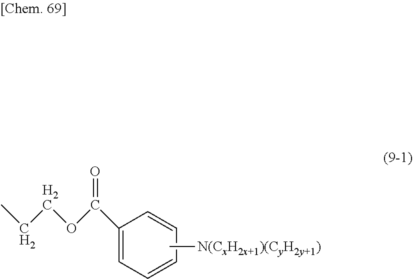

(x represents an integer of 1 to 4, and y represents an integer of 1 to 4).

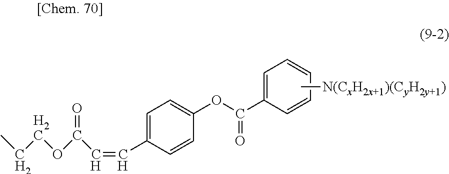

(x represents an integer of 1 to 4, and y represents an integer of 1 to 4).

The polyamic acid having a structural unit represented by Formula (6) may be a polyamic acid having a structural unit represented by the following Formula (6-0), a polyamic acid having a structural unit represented by the following Formula (6-1), a polyamic acid having a structural unit represented by the following Formula (6-2), or a polyamic acid having a structural unit represented by the following Formula (6-3).

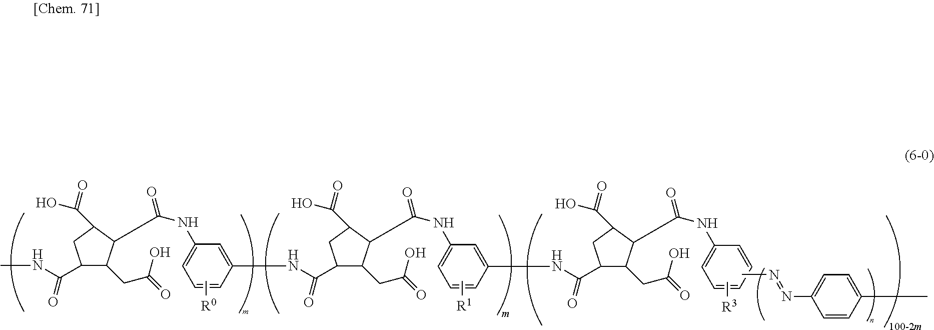

(m and (100-2m) represent copolymerization rates (mol %) of the respective structural units, where m is higher than 0 and not higher than 50; R⁰ represents a functional group represented by the following Formula (8); R¹ represents a functional group represented by the following Formula (9); and R³ represents a photoreactive functional group, a vertically aligning group, or a horizontally aligning group).

Examples of the photoreactive functional group, the vertically aligning group, and the horizontally aligning group represented by R³ include the above-mentioned monovalent photoreactive functional groups, vertically aligning groups, and horizontally aligning groups, excluding those represented by R⁰ or R¹.

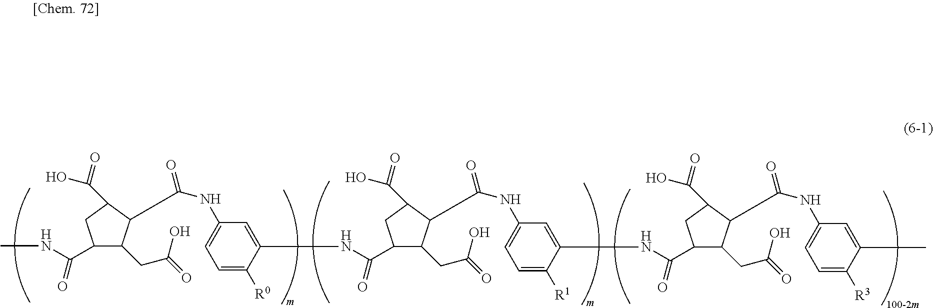

(m and (100-2m) represent copolymerization rates (mol %) of the respective structural units, where m is higher than 0 and not higher than 50; R⁰ represents a functional group represented by Formula (8); R¹ represents a functional group represented by Formula (9); and R³ represents a photoreactive functional group or a vertically aligning group).

Examples of the photoreactive functional group and the vertically aligning group represented by R³ include the above-mentioned monovalent photoreactive functional groups and vertically aligning groups, excluding those represented by R⁰ or R¹.

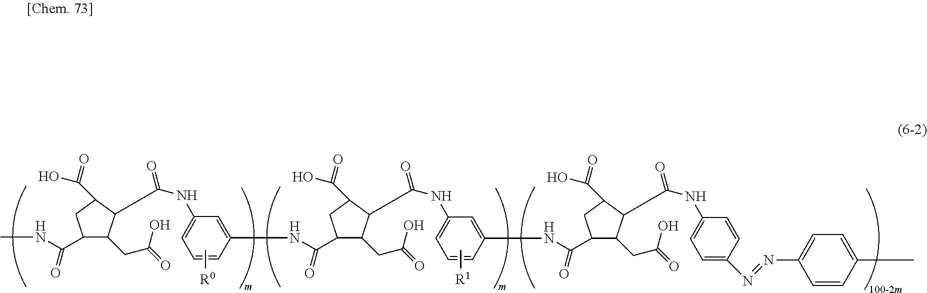

(m and (100-2m) represent copolymerization rates (mol %) of the respective structural units, where m is higher than 0 and not higher than 50; R⁰ represents a functional group represented by Formula (8); and R¹ represents a functional group represented by Formula (9)).

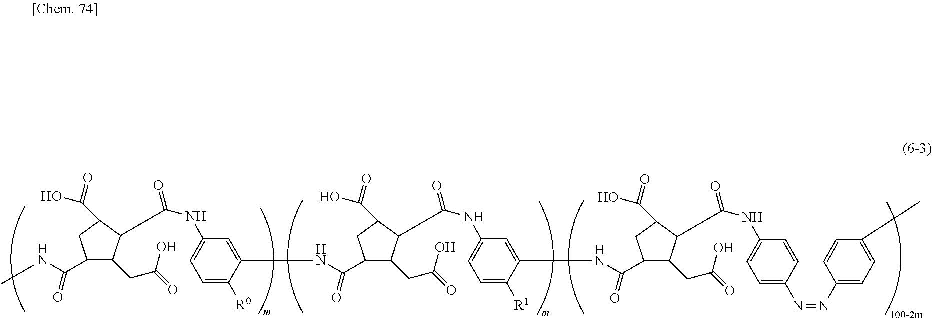

(m and (100-2m) represent copolymerization rates (mol %) of the respective structural units, where m is higher than 0 and not higher than 50; R⁰ represents a functional group represented by Formula (8); and R¹ represents a functional group represented by Formula (9)).

The polyamic acid having a structural unit represented by Formula (6-0), the polyamic acid having a structural unit represented by Formula (6-1), the polyamic acid having a structural unit represented by Formula (6-2), and the polyamic acid having a structural unit represented by Formula (6-3) as the polyamic acid used in the alignment film or the polyamic acid as the precursor of the polyimide used in the alignment film may each be a random copolymer or a block copolymer. From the viewpoint of uniformly distributing the radical polymerization starting point on the surface of the alignment film 12, these polyamic acids are all preferably random copolymers.

As the polyamic acid used in the alignment film or the polyamic acid as the precursor of the polyimide used in the alignment film, the polyamic acid having a structural unit represented by Formula (6-0), the polyamic acid having a structural unit represented by Formula (6-1), the polyamic acid having a structural unit represented by Formula (6-2), and the polyamic acid having a structural unit represented by Formula (6-3) may each have a weight-average molecular weight (Mw) within a range of 3,000 to 1,000,000 or within a range of 10,000 to 100,000 and a molecular weight distribution (Mw/Mn) within a range of 1 to 4 or within a range of 2 to 3.

The polyimide for the alignment film can be obtained by intramolecular cyclization (imidization) of a part or the whole of a polyamic acid as a precursor of the polyimide.

The alignment film may be made of a polyimide having a structure unit represented by the following Formula (7):

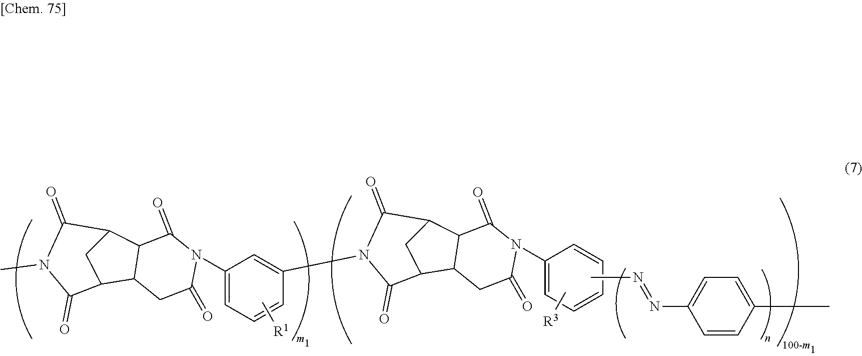

(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group).

The polyimide having a structural unit represented by Formula (7) can be obtained by intramolecular cyclization (imidization) of at least a part of a polyamic acid represented by Formula (6) as a precursor of the polyimide.

The polyimide having a structural unit represented by Formula (7) may be a polyimide having a structural unit represented by the following Formula (7-0), a polyimide having a structural unit represented by the following Formula (7-1), a polyimide having a structural unit represented by the following Formula (7-2), or a polyimide having a structural unit represented by the following Formula (7-3).

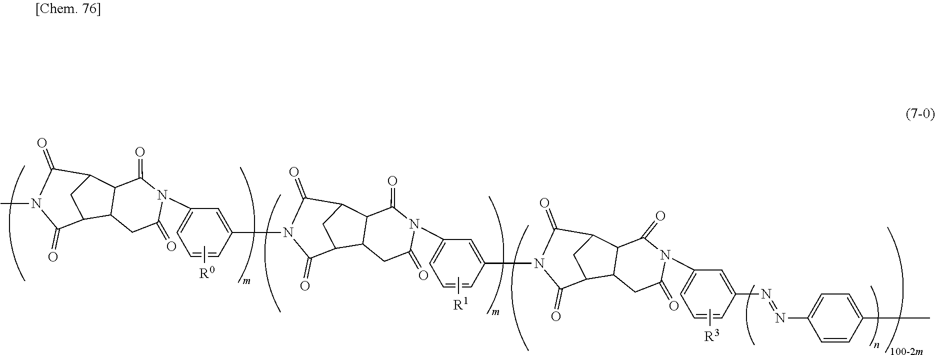

(m and (100-2m) represent copolymerization rates (mol %) of the respective structural units, where m is higher than 0 and not higher than 50; R⁰ represents a functional group represented by Formula (8); R¹ represents a functional group represented by Formula (9); R³ represents a photoreactive functional group, a vertically aligning group, or a horizontally aligning group).

Examples of the photoreactive functional group, the vertically aligning group, and the horizontally aligning group represented by R³ include the above-mentioned monovalent photoreactive functional groups, vertically aligning groups, and horizontally aligning groups, excluding those represented by R⁰ or R¹.

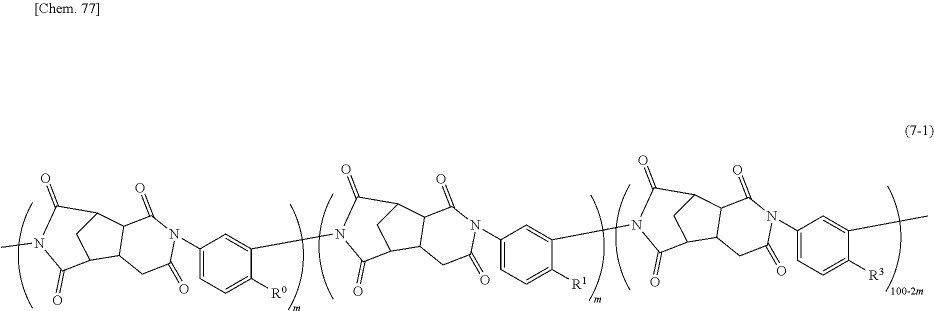

(m and (100-2m) represent copolymerization rates (mol %) of the respective structural units, where m is higher than 0 and not higher than 50; R⁰ represents a functional group represented by Formula (8); R¹ represents a functional group represented by Formula (9); and R³ represents a photoreactive functional group or a vertically aligning group).

Examples of the photoreactive functional group and the vertically aligning group represented by R³ include the above-mentioned monovalent photoreactive functional groups and vertically aligning groups, excluding those represented by R⁰ or R¹.

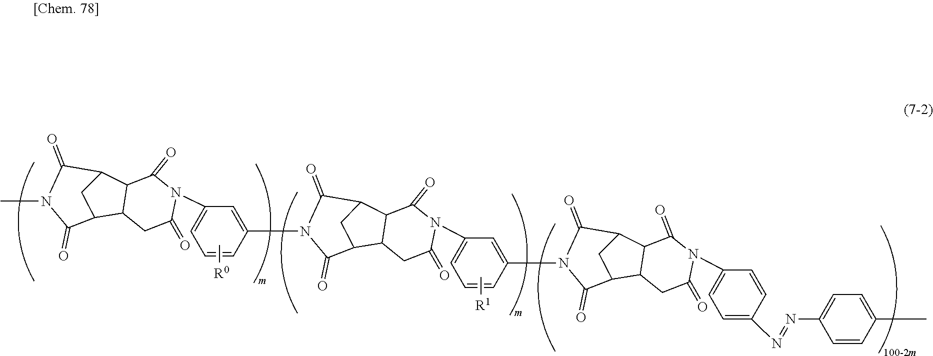

(m and (100-2m) represent copolymerization rates (mol %) of the respective structural units, where m is higher than 0 and not higher than 50; R⁰ represents a functional group represented by Formula (8); and R¹ represents a functional group represented by Formula (9)).

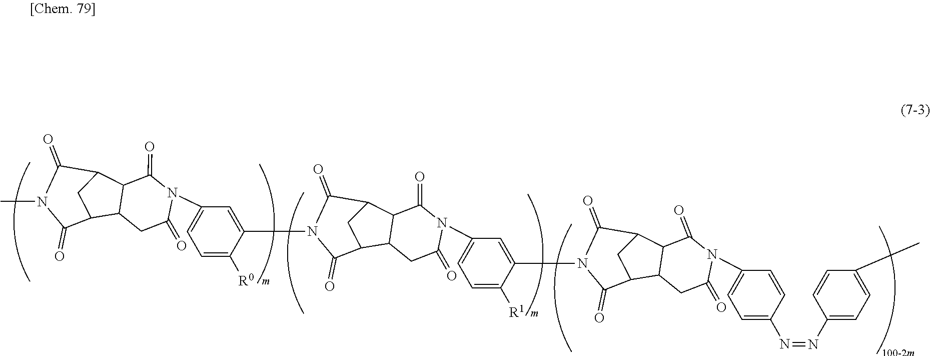

(m and (100-2m) represent copolymerization rates (mol %) of the respective structural units, where m is higher than 0 and not higher than 50; R⁰ represents a functional group represented by Formula (8); and R¹ represents a functional group represented by Formula (9)).

The imidization rate of a polyimide as the alignment film-forming material may be 10% or more, 30% or more, 40% or more, 50% or more, or 60% or more.

The imidization rate of a polyimide can be determined by FT-IR measurement of an alignment film. The alignment film is thoroughly heated at 350° C., which is defined as complete imidization (imidization rate: 100%), and the peak intensity derived from the amide group in FT-IR is used for determination.

At the time of manufacturing, in an FT-IR spectrum of an alignment film, a peak appearing near 1510 cm⁻¹ that can be identified as derived from a C—C bond of an aromatic ring is used as a basis for standardization.

It is inferred that the intensity and area of the peak derived from a C—C bond do not change even after heat treatment. On the other hand, a peak that corresponds to C—N stretching vibration of an imide group and can be identified as derived from an imide ring appears near 1370 cm⁻¹ and increases with progress of heat treatment. Accordingly, each calculation is performed by standardizing the peak near 1370 cm⁻¹ with the peak near 1510 cm⁻¹.

The imidization rate when an alignment film is thoroughly heated at 350° C. is defined as 100%, and the alignment film with an imidization rate of 100% is subjected to FT-IR measurement. The peak near 1370 cm⁻¹ in the resulting FT-IR spectrum is standardized with the peak near 1510 cm⁻¹. The resulting value is referred to as “A”.

In also the FT-IR spectrum of the alignment film as a measurement object, similarly, the peak near 1370 cm⁻¹ is standardized with the peak near 1510 cm⁻¹. The resulting value is referred to as “B”.

The imidization rate is determined using the respective values by the following expression:

Imidization rate(%)=B/A×100.

The polyimide having a structural unit represented by Formula (7), the polyimide having a structural unit represented by Formula (7-0), the polyimide having a structural unit represented by Formula (7-1), and the polyimide having a structural unit represented by Formula (7-2) as the polyimide used in the alignment film may each be a random copolymer or a block copolymer. From the viewpoint of uniformly distributing the radical polymerization starting point on the surface of the alignment film 12, these polyimides are preferably random copolymers.

These polyimides used in the alignment film may each have a weight-average molecular weight (Mw) within a range of 3,000 to 1,000,000 or within a range of 10,000 to 100,000 and a molecular weight distribution (Mw/Mn) within a range of 1 to 4 or within a range of 2 to 3.

### (Polysiloxane)

Examples of the polysiloxane for the alignment film include polysiloxanes that have a siloxane skeleton represented by the following Formula (20) or a siloxane skeleton represented by the following Formula (21) and have a Z unit including a covalently bonded functional group represented by Formula (1) as a side chain.

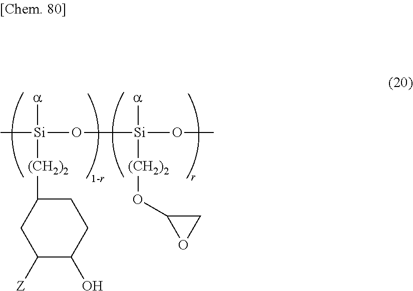

(where, α represents a hydrogen atom, a hydroxy group, or an alkoxy group, and multiple α's may be the same as or different from each other; and

r is within a range of 0<r≤0.5, and (1−r) and r represent the copolymerization rates of the respective structural units).

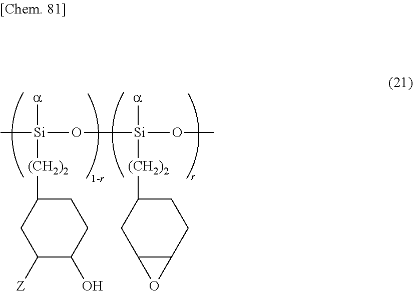

(where, α represents a hydrogen atom, a hydroxy group, or an alkoxy group, and multiple α's may be the same as or different from each other; and

r is within a range of 0<r≤0.5, and (1−r) and r represent the copolymerization rates of the respective structural units).

Examples of the alignment film having a siloxane acid skeleton include those that have a siloxane skeleton represented by Formula (20) or a siloxane skeleton represented by Formula (21) and have a Z unit including a photoreactive functional group as a side chain. Examples of the photoreactive functional group include those represented by the following Formulae (Z-224) and (Z-225).

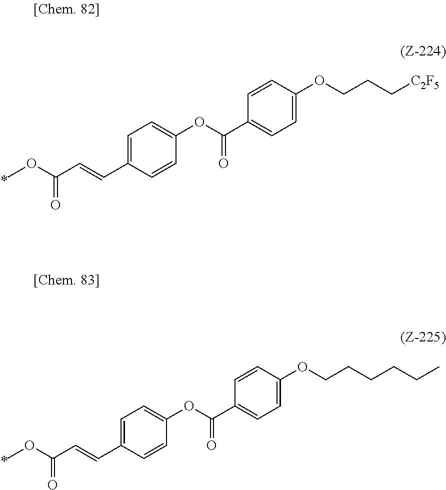

At least one of the multiple Z units may have a photoreactive functional group. The photoreactive functional group may be any of those represented by Formulae (Z-101) to (Z-103).

At least one of the multiple Z units may be any of those represented by Formulas (Z-301) to (Z-307).

The photoreactive functional group may be directly bonded to a silicon atom contained in the siloxane skeleton or may be included in the side chain that is bonded to a silicon atom. The photoreactive functional group is preferably included in a side chain, because it is easy to cause a photoreaction and it is possible to reduce the irradiation amount of light for causing the photoreaction. In addition, not all side chains need to contain photoreactive functional groups, and a non-photoreactive side chain, such as a polymerizable functional group that thermally crosslinks, may be included for improving thermal and chemical stability.

These photoreactive functional groups absorb polarized light in the respective absorbing bands of the photoreactive functional groups to cause photoisomerization or dimerization reaction. As a result, the structure of the photoreactive functional group is changed, and the alignment film 12 regulates the alignment direction of the liquid crystal material close to the surface to an arbitrary direction. That is, the alignment film 12 can regulate the alignment direction of the liquid crystal material to an arbitrary direction depending on the irradiation direction of polarized light irradiated during the formation.

### [Liquid Crystal Layer]

The liquid crystal layer 30 contains a liquid crystal material. The liquid crystal material is a composition that includes liquid crystal molecules having liquid crystalline properties. The liquid crystal material may be composed only of liquid crystal molecules that independently exhibit liquid crystalline properties or may be a composition that is a mixture of liquid crystal molecules independently exhibiting liquid crystalline properties and an organic compound not independently exhibiting liquid crystalline properties and exhibits liquid crystalline properties as a whole. The liquid crystal material may be a negative liquid crystal material having negative dielectric anisotropy or a positive liquid crystal material having positive dielectric anisotropy. The liquid crystal molecules are provided with alignment depending on the alignment regulating force of the alignment film 12 and a second alignment film 22 when no voltage is applied.

Examples of the positive liquid crystal material having positive dielectric anisotropy include a mixture of a polar liquid crystal compound having positive dielectric anisotropy and a non-polar liquid crystal compound. Examples of the polar liquid crystal compound having positive dielectric anisotropy include the following compounds:

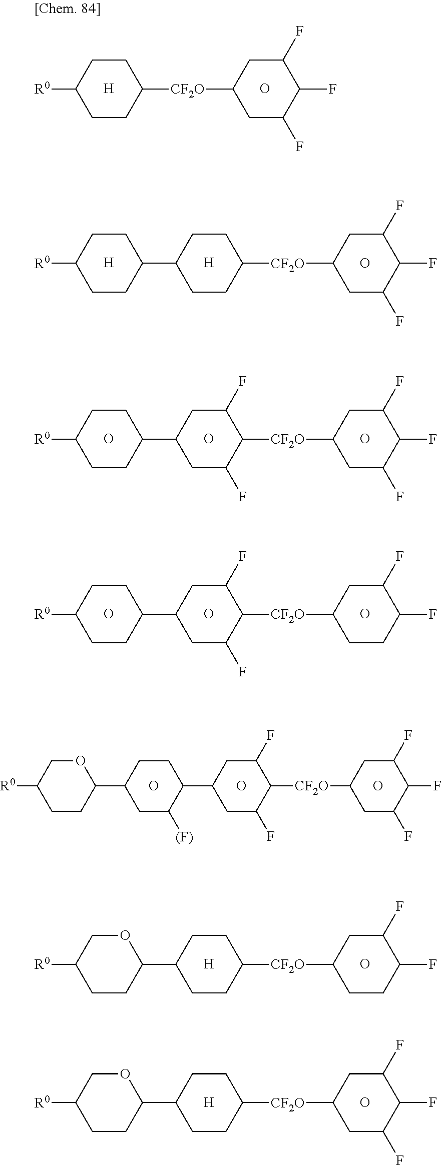

(where, R⁰ represents a saturated alkyl group having 1 to 12 carbon atoms).

Examples of the negative liquid crystal material having negative dielectric anisotropy include a mixture of a polar liquid crystal compound of negative dielectric anisotropy and a non-polar liquid crystal compound. Examples of the polar liquid crystal compound having negative dielectric anisotropy include the following compounds:

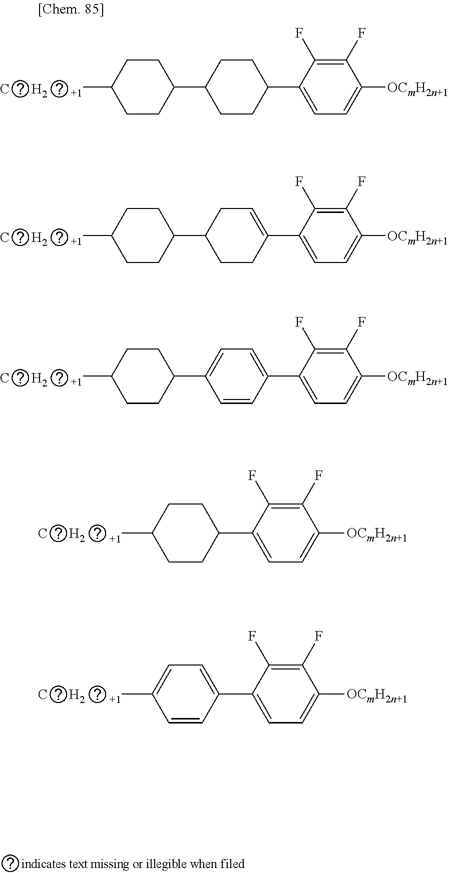

(where, n and m each represent an integer of 1 to 18).

The non-polar liquid crystal compounds of the positive liquid crystal material and the negative liquid crystal material are the same, and examples thereof include the following compounds:

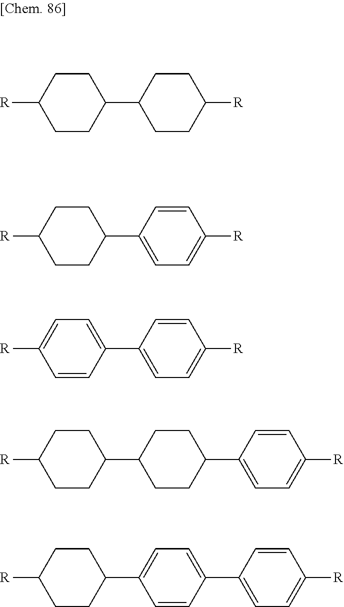

(where, R represents a straight-chain alkyl group having 1 to 8 carbon atoms).

Furthermore, the liquid crystal display device 100 may include a sealing member sandwiched between the element substrate 10 and the counter substrate 20 and surrounding the periphery of the liquid crystal layer 30 and a spacer that is a columnar structure for regulating the thickness of the liquid crystal layer 30.

The liquid crystal display device having such a configuration can easily change the pretilt angle while suppressing a decrease in contrast.

### [Alignment-Sustaining Layer]

An alignment-sustaining layer 40 is provided between the alignment film 12 and the liquid crystal layer 30 and regulates the tilt direction of at least liquid crystal molecules close to the alignment film 12 among the liquid crystal molecules constituting the liquid crystal layer 30.

Also on the counter substrate 20 side, a second alignment-sustaining layer 50 may be provided between the second alignment film 22 and the liquid crystal layer 30 and regulate the tilt direction of at least liquid crystal molecules close to the second alignment film 22 among the liquid crystal molecules constituting the liquid crystal layer 30.

The alignment-sustaining layer 40 and the second alignment-sustaining layer 50 may be each formed by radical polymerization of a radical polymerizable monomer.

The alignment-sustaining layer 40 and the second alignment-sustaining layer 50 are each formed from a photopolymerization product and has functions of regulating the alignment direction of the liquid crystal molecules of the liquid crystal layer 30 when no voltage is applied to the liquid crystal layer 30 and regulating the function of improving the alignment regulating force. The alignment-sustaining layer 40 and the second alignment-sustaining layer 50 can be formed from a photopolymerizable monomer, for example, a dimethacrylate represented by the following Formula (29), a dimethacrylate represented by the following Formula (30), or a dimethacrylate represented by the following Formula (31).

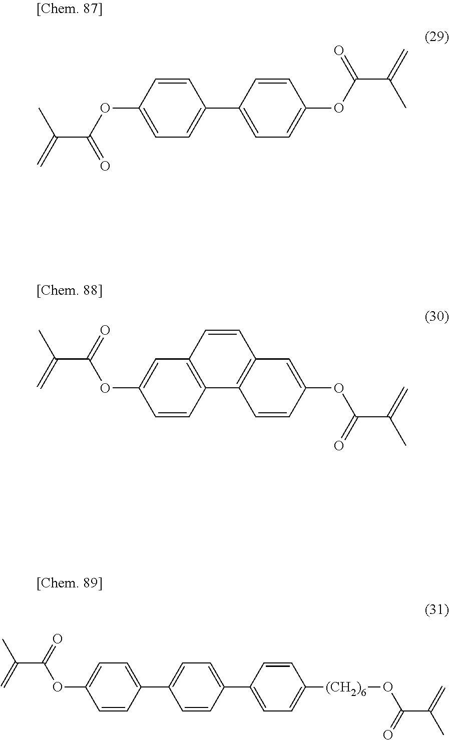

The alignment-sustaining layer is formed using, for example, a mixture of 0.5 mass % or less of a dimethacrylate mentioned above and 100 mass % of a liquid crystal material that is used for the liquid crystal layer 30.

A pair of substrates are adhered to each other with such a liquid crystal material and are then irradiated with light (using a fluorescent lamp) of 400 nm or more through a filter that cuts light of 400 nm or less for 15 minutes in a voltage application or no voltage application state. Consequently, the dimethacrylate as described above forms an alignment-sustaining layer as if fell on the surface of the alignment film.

The liquid crystal display device 100 including such alignment-sustaining layers 40, 50 has high quality with reduced VHR (Voltage Holding Ratio), residual DC, and change in pretilt angle.

### [Counter Substrate]

The counter substrate 20 includes, for example, a color filter substrate 21, a second alignment film 22 provided on the surface of the color filter substrate 21 on the liquid crystal layer 30 side, and a second polarizing plate 29 (not shown) provided on the opposite side of the color filter substrate 21 from the liquid crystal layer 30. The polarizing plate 29 can have a usually known configuration.

The color filter substrate 21 includes, for example, a red color filter layer that absorbs a part of incident light and transmits red light, a green color filter layer that absorbs a part of incident light and transmits green light, and a blue color filter layer that absorbs a part of incident light and transmits blue light

Furthermore, the color filter substrate 21 may include an overcoat layer covering the surface for flattening the substrate surface and preventing elution of the color material components from the color filter layers.

### [Second Alignment Film]

The second alignment film 22 has a function of imparting alignment regulating force to the liquid crystal material being in contact with the surface. The second alignment film 22 may be a vertical alignment film, a horizontal alignment film, or a photo-alignment film that imparts a pretilt angle to the liquid crystal material.

When both the alignment film 12 and the second alignment film 22 are photo-alignment films, the pretilt angle imparted to the liquid crystal material by the alignment film 12 and the pretilt angle imparted to the liquid crystal material by the second alignment film 22 may be the same or different.

When both the alignment film 12 and the second alignment film 22 are photo-alignment films, the alignment direction of the liquid crystal material regulated by the alignment film 12 and the alignment direction of the liquid crystal material regulated by the second alignment film 22 can be set to anti-parallel alignment in a view from the normal direction of the TFT substrate 11 (a view when the TFT substrate is planarly viewed). The term “anti-parallel alignment” refers to that liquid crystal materials have the same azimuth angle in a view when a TFT substrate is planarly viewed.

### [Method for Manufacturing Liquid Crystal Display Device]

In a method for manufacturing a liquid crystal display device 100 of the embodiment, an alignment film-forming material containing a polymer compound having a covalently bonded functional group represented by Formula (1) is formed into a film on a substrate 11; the forming material formed into a film is subjected to alignment treatment to form an alignment film 12 on the substrate 11; a liquid crystal material containing a monomer is injected between the alignment film 12 and a counter substrate 20 to form a liquid crystal layer 30; and the monomer is then polymerized to form an alignment-sustaining layer 40 between the alignment film 12 and the liquid crystal layer 30, where the alignment-sustaining layer 40 regulates the tilt direction of at least liquid crystal molecules close to the alignment film 12 among the liquid crystal molecules constituting the liquid crystal layer 30.

While preferred embodiments according to the present invention have been described with reference to the accompanying drawing, the present invention is not limited to such examples. The shapes, combinations, etc. of each component shown in the above-described examples are merely examples and can be variously modified based on, for example, design requirements without departing from the gist of the present invention.

### EXAMPLES

The present invention will now be described in detail by examples but is not limited to these examples.

### [Synthesis of Diamine Monomer (Tertiary Amine Side)]

An example of synthesis of a diamine monomer (raw material monomer (A)) having a polymerization initiating functional group will be described below. In reaction formulae, numerical values shown as M.W. are molecular weights of each compound.

### (Process A)

Thionyl chloride was dropwise added to a benzene solution (20 mL) containing 4-(dimethylamino)benzoic acid (0.83 g, 5 mmol) represented by the following formula (2) to synthesize 4-(dimethylamino)benzoyl chloride (4.65 mmol, yield: 93%) represented by the formula (3). Subsequently, a benzene solution (5 mL) containing the 4-(diethylamino)benzoyl chloride (0.46 g, 2.5 mmol) represented by the formula (3) was dropwise added to a benzene solution (20 mL) containing trans-4-hydroxycinnamic acid methyl ester (0.45 g, 2.5 mmol) represented by the formula (1) and triethylamine (0.5 g, 5 mmol) at room temperature in a nitrogen atmosphere, followed by a reaction for 2 hours at room temperature. After completion of the reaction, impurities were extracted with water, and purification by column chromatography (toluene/ethyl acetate (4/1)) was performed to obtain a target compound (0.692 g, yield: 86%) represented by the following formula (4).

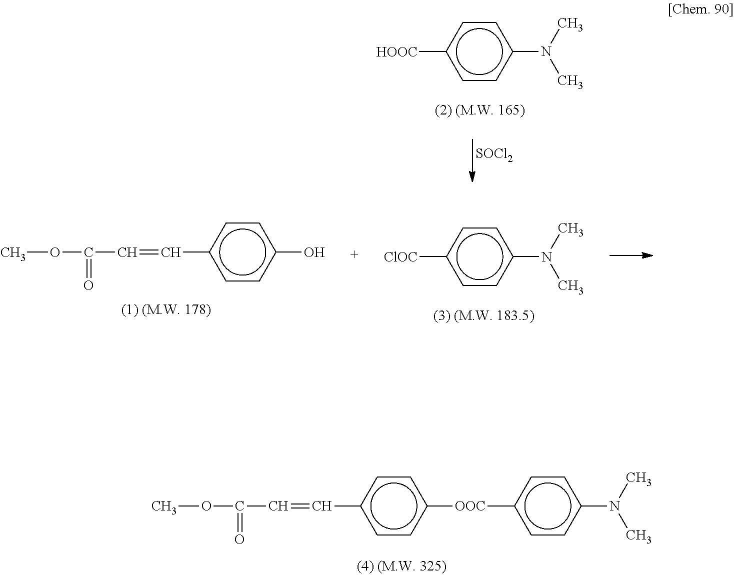

### (Process B)

A sodium hydroxide aqueous solution and then hydrochloric acid were dropwise added to a THF/methanol mixture solution (20 mL) containing the compound (0.65 g, 2 mmol) represented by the formula (4), followed by stirring for 1 hour to synthesize a carboxylic acid compound (0.59 g, 1.9 mmol) represented by the following formula (5).

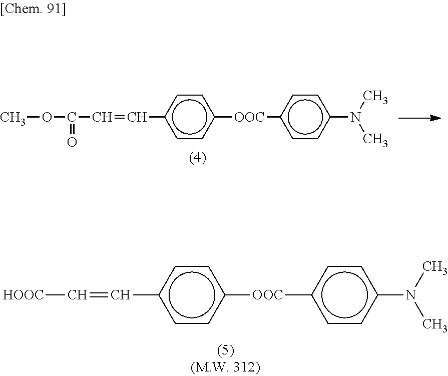

### (Process C)

Dinitrophenylacetic acid (3 g) represented by the following formula (6) was dissolved in THF (20 mL), and dimethyl sulfide borane-toluene solution (7 mL) was dropwise added to the solution. The resulting mixture was left to stand at room temperature overnight, and a 50% methanol aqueous solution (10 mL) was dropwise added thereto to terminate the reaction. Subsequently, extraction with chloroform (10 mL) and washing with 5% sodium bicarbonate water and water were performed, and concentration was performed until no extraction into the organic phase was observed. The resulting liquid was dissolved in chloroform (20 mL), followed by purification by alumina column chromatography. The distillate was concentrated, and toluene/n-heptane solution (6/4) was added to the concentrate to separate the components that were thermally extracted at 70° C. The component in the upper phase was decanted and was cooled to obtain 2,4-dinitrophenylethanol (1.2 g, yield: 42.7%) represented by the following formula (7).

2,4-Dinitrophenylethanol (0.4 g) represented by the following formula (7) was dissolved in Solmix (registered trademark) AP-I (8 mL, Japan Alcohol Trading Co., Ltd.), Raney Ni (0.06 g) was added thereto, and the mixture was charged in an autoclave. The system was replaced with hydrogen, followed by leaving to stand at room temperature overnight under a pressure of 0.4 MPa. Termination of the reaction was verified by HPLC, and the reaction solution was filtered through Celite (registered trademark).

The filtrate was concentrated until no distillation was observed. The resulting crude liquid was distilled under reduced pressure to obtain 2,4-diaminophenylethanol (0.69 g, yield: 80%) represented by the following formula (8).

2,4-Diaminophenylethanol (0.6 g) represented by the formula (8) was dissolved in acetone (5 mL), and t-butoxycarbonyl anhydride (1.8 g/THF 5 mL) was dropwise added thereto. After the dropwise addition, the solution was heated to reflux temperature and was left to stand overnight. After completion of the reaction, the reaction solution was concentrated and dried to obtain a t-Boc form (0.13 g, yield: 94%) represented by the following formula (9).

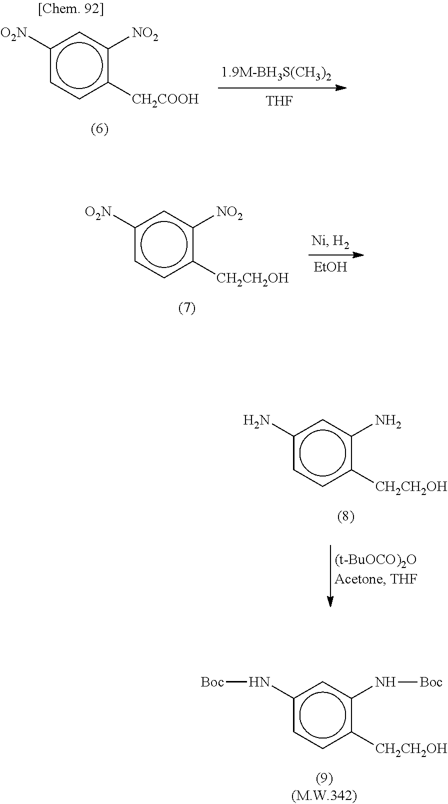

### (Process D)

The t-Boc form represented by the following formula (9) and the carboxylic acid compound represented by the following formula (5) were reacted by a method equivalent to the method described in the (Process A) to synthesize a t-Boc form represented by the following formula (10).

The t-Boc form represented by the formula (10) was further converted to diamine to synthesize a target diamine monomer represented by the following formula (11).

A method for synthesizing a monomer represented by the formula (11) from the t-Boc form represented by the formula (10) will be described below.

The t-Boc form represented by the formula (10) was dissolved in methylene chloride, and tin(II) trifluoromethanesulfonate (Sn(OTf)₂) was separately charged to the solution at 0° C. After reaction at room temperature, neutralization was performed by addition of 5% NaHCO₃ aq. Subsequently, washing with water was performed until the solution became neutral, and the organic phase was dried with anhydrous magnesium sulfate, followed by filtering through Celite. The filtrate was concentrated to obtain a diamine monomer represented by the following formula (11).

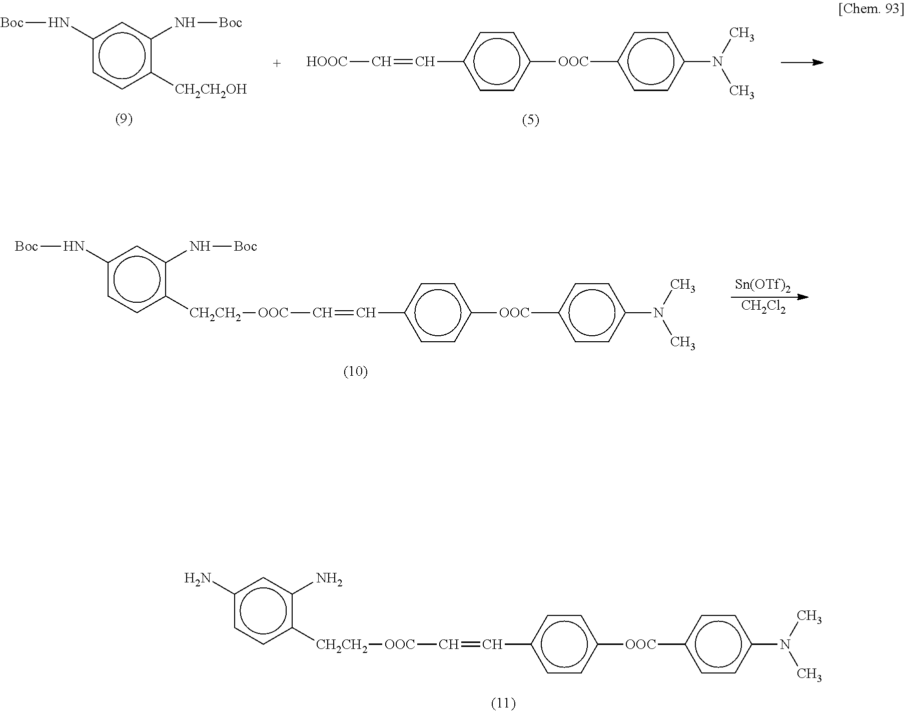

The diamine monomer represented by the formula (11) corresponds to the above-described monomer when j=1, x=1, and y=1. The monomer when j=2, x=1, and y=1 can be synthesized by using a compound represented by the formula (2) instead of the compound represented by the formula (5) through the synthesis route repeating the (Process A) and the (Process B): (Process A)→(Process B)→(Process A)→(Process B)→(Process C)→(Process D). The monomer when j=3, x=1, and y=1 can be similarly synthesized through the synthesis route repeating the (Process A) and the (Process B): (Process A)→(Process B)→(Process A)→(Process B)→(Process A)→(Process B)→(Process C)→(Process D).

### [Synthesis of Diamine Monomer Having Thioxanthone Group (Thioxanthone Side)]

The diamine monomer having a thioxanthone group represented by the following Formula (12) can be synthesized by using a 2-chlorothioxanthone represented by the following Formula (13) instead of the synthesis starting compound (3) in the (Process A) through completely the same synthesis route of the (Process A) to the (Process D).

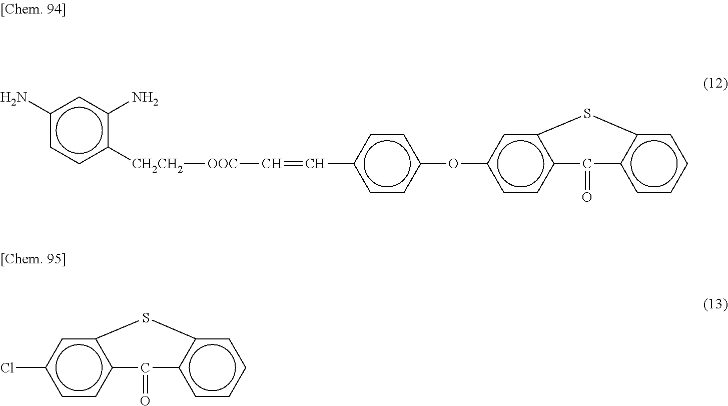

The diamine monomer represented by Formula (12) corresponds to the above-described monomer when k=1. The monomer when k=2 can be similarly synthesized through the synthesis route repeating the (Process A) and the (Process B): (Process A)→(Process B)→(Process A)→(Process B)→(Process C)→(Process D). The monomer when k=3 can be similarly synthesized through the synthesis route repeating the (Process A) and the (Process B): (Process A)→(Process B)→(Process A)→(Process B)→(Process A)→(Process B)→(Process C)→(Process D).

### Examples 1 to 5 and Comparative Example 1

Synthesis of a polyamic acid in which the introduction amount of a functional group having a radical polymerization-initiating function is 40 mol % (Example 2: m=20, m₁=2m=40) will be described as an example of the method for synthesizing polyamic acids of Examples 1 to 5 and Comparative Example 1.

A diamine monomer (0.06 mol) represented by the following Formula (15) having a photoreactive functional group, a diamine monomer (0.02 mol) represented by the following Formula (11) having a radical polymerization-initiating function, and a diamine monomer (0.02 mol) represented by the following Formula (12) having a radical polymerization-initiating function were dissolved in γ-butyrolactone, and acid anhydride (0.10 mol) represented by the following Formula (14) was added to the solution, followed by a reaction at 60° C. for 12 hours to obtain a polyamic acid in which, in Formula (6-1), R⁰ is a functional group represented by the following Formula (8-2) having a radical polymerization-initiating function, R¹ is a functional group represented by the following Formula (9-2-1) having a radical polymerization-initiating function, and R³ is a photoreactive functional group represented by the following Formula (Z-219) and is also a vertically aligning group. The resulting polyamic acid (Example 2) had a weight-average molecular weight (Mw) of 30,000 and a molecular weight distribution (Mw/Mn) of 2.5.

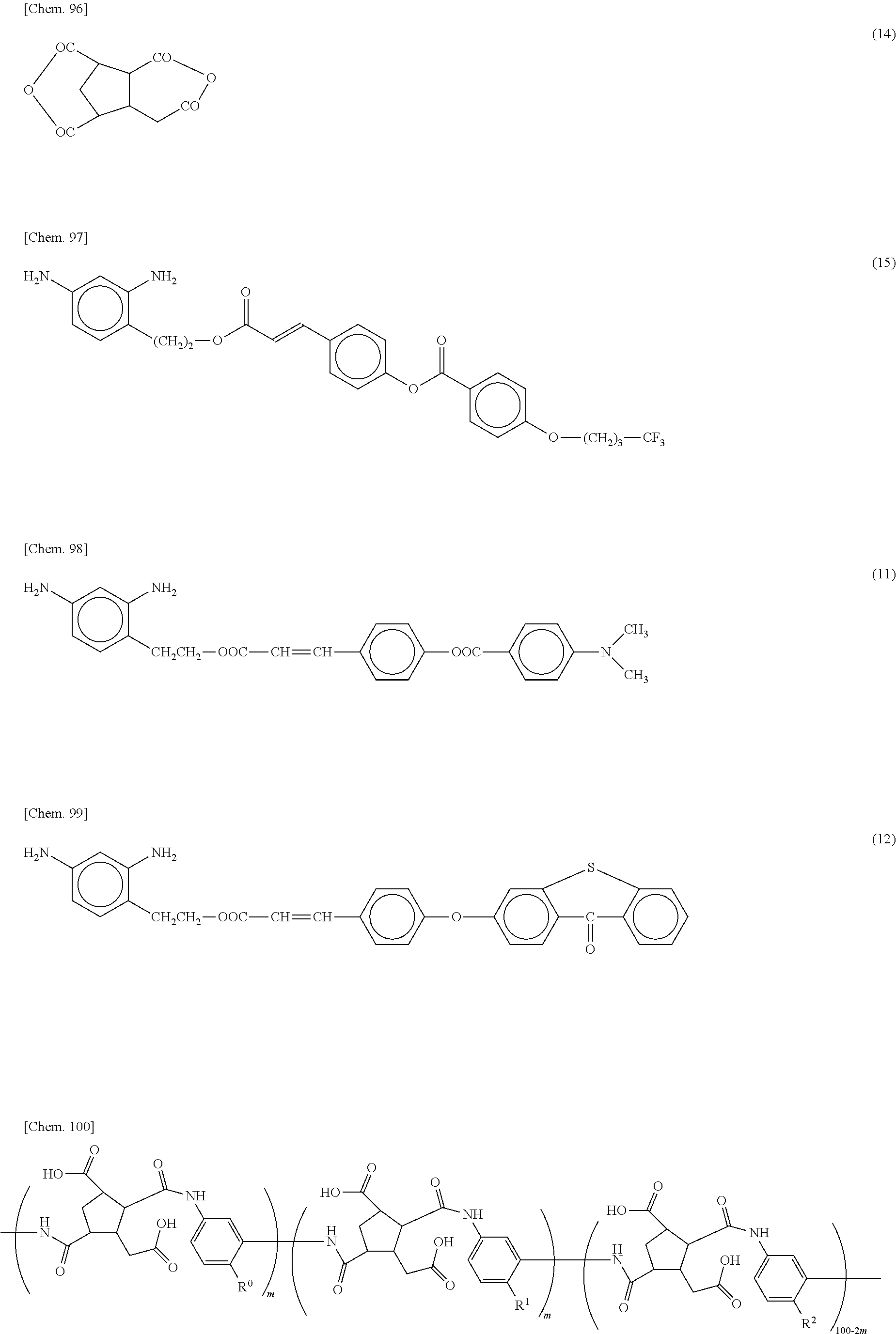

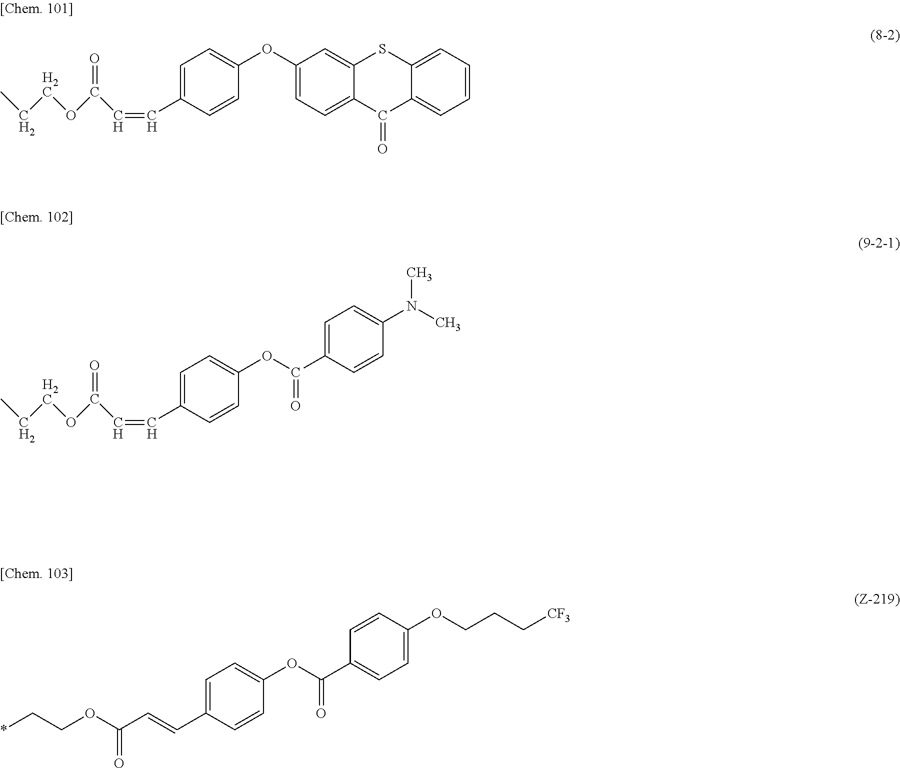 [SMILES: CCCOC(=O)/C=C\c1ccc(Oc2ccc3c(=O)c4ccccc4sc3c2)cc1 ; CCCOC(=O)/C=C\c1ccc(OC(=O)c2ccc(N(C)C)cc2)cc1 ; *CCOC(=O)/C=C/c1ccc(OC(=O)c2ccc(OCCCC(F)(F)F)cc2)cc1]

Similarly, a polyamic acid having a polymerization structure in which the introduction amount of a functional group having a radical polymerization-initiating function was 0 mol % (m=0, m=2m=0) was synthesized. The resulting polyamic acid (Comparative Example 1) had a weight-average molecular weight (Mw) of 30,000 and a molecular weight distribution (Mw/Mn) of 2.5.

Similarly, a polyamic acid having a random copolymer structure in which the introduction amount of a functional group having a radical polymerization-initiating function was 20 mol % (m=10, m₁=2m=20) was synthesized. The resulting polyamic acid (Example 1) had a weight-average molecular weight (Mw) of 30,000 and a molecular weight distribution (Mw/Mn) of 2.5.

Similarly, a polyamic acid having a random copolymer structure in which the introduction amount of a functional group having a radical polymerization-initiating function was 60 mol % (m=30, m₁=2m=60) was synthesized. The resulting polyamic acid (Example 3) had a weight-average molecular weight (Mw) of 30,000 and a molecular weight distribution (Mw/Mn) of 2.5.

Similarly, a polyamic acid having a random copolymer structure in which the introduction amount of a functional group having a radical polymerization-initiating function was 80 mol % (m=40, m₁=2m=80) was synthesized. The resulting polyamic acid (Example 4) had a weight-average molecular weight (Mw) of 30,000 and a molecular weight distribution (Mw/Mn) of 2.5.

Similarly, a polyamic acid having a polymer structure in which the introduction amount of a functional group having a radical polymerization-initiating function was 100 mol % (m=50, m₁=2m=100) was synthesized. The resulting polyamic acid (Example 5) had a weight-average molecular weight (Mw) of 30,000 and a molecular weight distribution (Mw/Mn) of 2.5.

### Examples 6 to 10 and Comparative Example 2

The polyamic acid prepared in Example 2 was imidized by the following treatment.

Excessive amounts of pyridine (0.5 mol) and acetic anhydride (0.3 mol) were added to a y-butyrolactone solution of the polyamic acid prepared in Example 2, followed by a reaction at 150° C. for 3 hours.

The thus-prepared polyimide of Example 7 had a weight-average molecular weight (Mw) of 30,000 and a molecular weight distribution (Mw/Mn) of 2.5. In addition, the imidization rate was 20% or more.

Similarly, the polyamic acid prepared in Comparative Example 1 was imidized to obtain a polyimide of Comparative Example 2 having a weight-average molecular weight (Mw) of 30,000 and a molecular weight distribution (Mw/Mn) of 2.5. The imidization rate was 20% or more.

Similarly, the polyamic acid prepared in Example 1 was imidized to obtain a polyimide of Example 6 having a weight-average molecular weight (Mw) of 30,000 and a molecular weight distribution (Mw/Mn) of 2.5. The imidization rate was 20% or more.

Similarly, the polyamic acid prepared in Example 3 was imidized to obtain a polyimide of Example 8 having a weight-average molecular weight (Mw) of 30,000 and a molecular weight distribution (Mw/Mn) of 2.5. The imidization rate was 20% or more.

Similarly, the polyamic acid prepared in Example 4 was imidized to obtain a polyimide of Example 9 having a weight-average molecular weight (Mw) of 30,000 and a molecular weight distribution (Mw/Mn) of 2.5. The imidization rate was 20% or more.

Similarly, the polyamic acid prepared in Example 5 was imidized to obtain a polyimide of Example 10 having a weight-average molecular weight (Mw) of 30,000 and a molecular weight distribution (Mw/Mn) of 2.5. The imidization rate was 20% or more.

### Examples 11 to 15 and Comparative Example 3

Synthesis of a polyamic acid in which the introduction amount of a functional group having a radical polymerization-initiating function is 30 mol % (Example 13: m=15, m₁=2m=30) will be described as an example of the method for synthesizing polyamic acids of Examples 11 to 15 and Comparative Example 3.

A diamine monomer (0.070 mol) represented by the following Formula (16) having a photoreactive functional group, a diamine monomer (0.015 mol) represented by the following Formula (17) having a radical polymerization-initiating function, and a diamine monomer (0.015 mol) represented by the following Example (18) having a radical polymerization-initiating function were dissolved in y-butyrolactone, and acid anhydride (0.10 mol) represented by the following Formula (14) was added to the solution, followed by a reaction at 60° C. for 12 hours to obtain a polyamic acid having a random copolymer structure represented by Formula (6-3), where R⁰ is a functional group represented by the following Formula (8-1) having a radical polymerization-initiating function, and R¹ is a functional group represented by the following Formula (9-1-1) having a radical polymerization-initiating function.

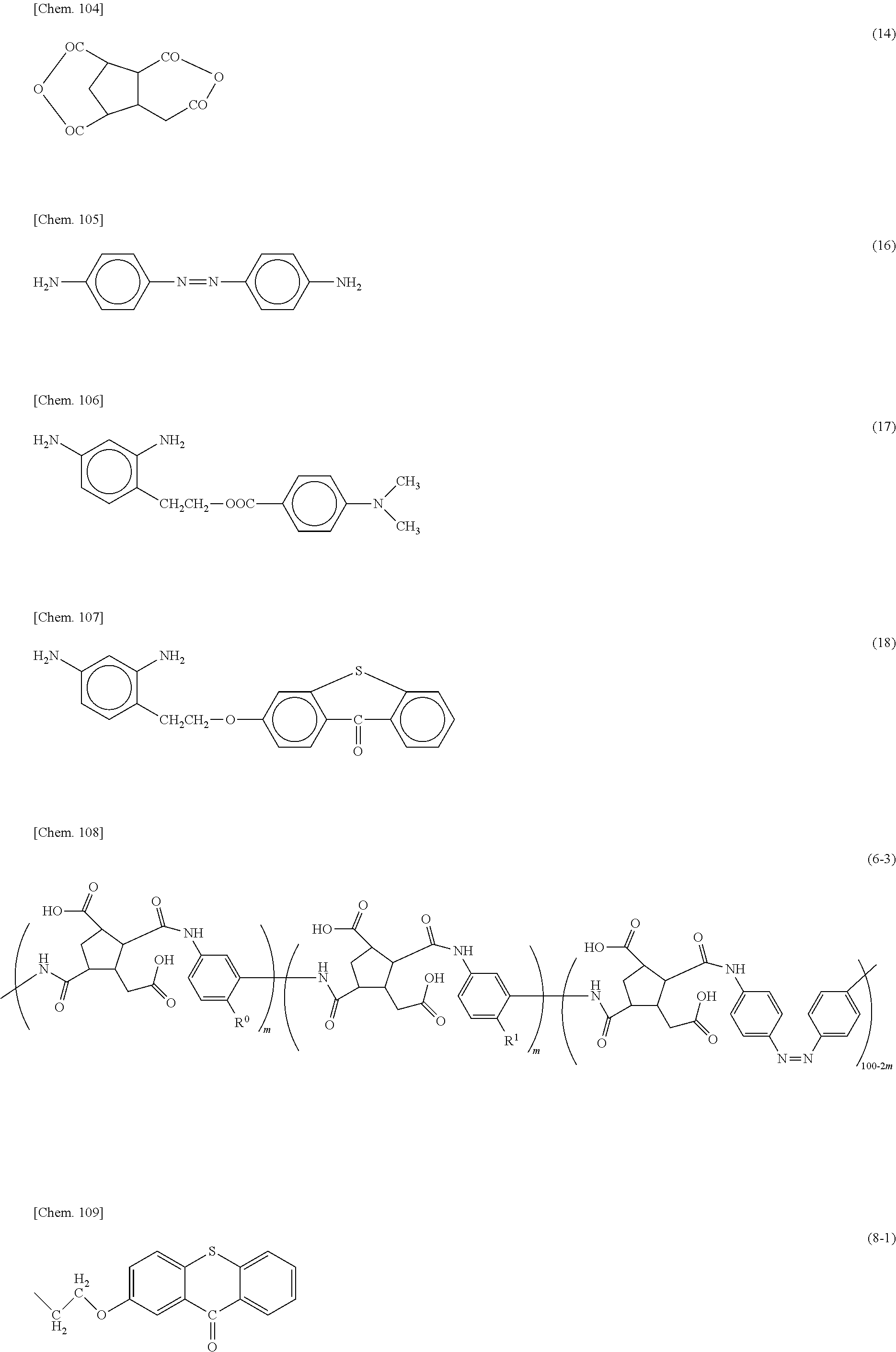

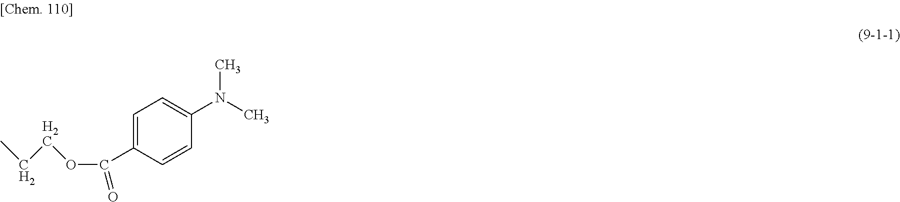

Similarly, a polyamic acid having a copolymer structure in which the introduction amount of a functional group having a radical polymerization-initiating function was 0 mol % (m=0, m=2m=0) was synthesized. The resulting polyamic acid (Comparative Example 2) had a weight-average molecular weight (Mw) of 30,000 and a molecular weight distribution (Mw/Mn) of 2.5.

Similarly, a polyamic acid having a random copolymer structure in which the introduction amount of a functional group having a radical polymerization-initiating function was 10 mol % (m=5, m₁=2m=10) was synthesized. The resulting polyamic acid (Example 11) had a weight-average molecular weight (Mw) of 30,000 and a molecular weight distribution (Mw/Mn) of 2.5.

Similarly, a polyamic acid having a random copolymer structure in which the introduction amount of a functional group having a radical polymerization-initiating function was 20 mol % (m=10, m₁=2m=20) was synthesized. The resulting polyamic acid (Example 12) had a weight-average molecular weight (Mw) of 30,000 and a molecular weight distribution (Mw/Mn) of 2.5.

Similarly, a polyamic acid having a random copolymer structure in which the introduction amount of a functional group having a radical polymerization-initiating function was 40 mol % (m=20, m₁=2m=40) was synthesized. The resulting polyamic acid (Example 14) had a weight-average molecular weight (Mw) of 30,000 and a molecular weight distribution (Mw/Mn) of 2.5.

Similarly, a polyamic acid having a random copolymer structure in which the introduction amount of a functional group having a radical polymerization-initiating function was 50 mol % (m=25, m₁=2m=50) was synthesized. The resulting polyamic acid (Example 15) had a weight-average molecular weight (Mw) of 30,000 and a molecular weight distribution (Mw/Mn) of 2.5.

### Examples 16 to 20 and Comparative Example 4

### (Process of Producing Liquid Crystal Cell)

As active matrix substrates, a TFT substrate having a display region of 10 inches and a thickness of 0.7 mm and a color filter substrate including a color filter were prepared. A solution of the polyamic acid prepared in Example 1, in which the introduction amount of the thioxanthone and dimethylamino functional group having a radical polymerization-initiating function was 10 mol % (m=10, m₁=2m=20), was applied onto a surface of the TFT substrate. After pre-baking at 80° C., past-baking by heating at 200° C. was performed for 60 minutes to form a film having a thickness of 100 nm. As the solvent, a mixture solvent of N-methylpyrrolidone (NMP) and γ-butyrolactone was used at a mass ratio of 1:1.

Subsequently, through a cut filter cutting wavelengths of 400 nm or more, linearly polarized ultraviolet light irradiation from an oblique direction was performed for alignment treatment. Since a polyamic acid having a side chain including a functional group represented by Formula (Z-219), being a vertically aligning group and also being a photoreactive functional group, is used, the resulting alignment film functions as a vertical alignment film made of the polyamic acid.

A seal was then applied to the TFT substrate having the polyamic acid vertical alignment film, beads were dispersed onto the color filter substrate, the substrates were then adhered to each other, and a liquid crystal material (Tni: 75° C., Δε: −3.5) showing negative dielectric anisotropy was injected therebetween. The liquid crystal material contained 0.25 mass % of a difunctional monomer represented by the following Formula (29).

After injection of the liquid crystal material, the liquid crystal material was heated up to 130° C., which is a temperature higher than the nematic phase transition temperature (Tni) of the liquid crystal material, and was rapidly cooled. Subsequently, the resulting cell was irradiated with light (using a fluorescent lamp) of 400 nm or more through a filter cutting 400 nm or less for 20 minutes, while not breaking the alignment treatment, to polymerize the monomer. Thus, a UV2A mode cell including the polyamic acid vertical alignment film of Example 16 was produced.

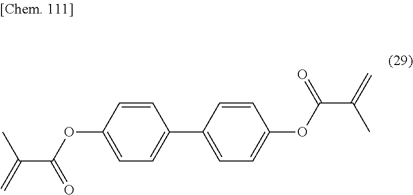 [SMILES: C=C(C)C(=O)Oc1ccc(-c2ccc(OC(=O)C(=C)C)cc2)cc1]

Similarly, a UV2A mode cell including the polyamic acid vertical alignment film of Example 17 was produced using the polyamic acid prepared in Example 2, in which the introduction amount of the thioxanthone and dimethylamino functional group having a radical polymerization-initiating function was 20 mol % (m=20, m₁=2m=40).

Similarly, a UV2A mode cell including the polyamic acid vertical alignment film of Example 18 was produced using the polyamic acid prepared in Example 3, in which the introduction amount of the thioxanthone and dimethylamino functional group having a radical polymerization-initiating function was 30 mol % (m=30, m₁=2m=60).

Similarly, a UV2A mode cell including the polyamic acid vertical alignment film of Example 19 was produced using the polyamic acid prepared in Example 4, in which the introduction amount of the thioxanthone and dimethylamino functional group having a radical polymerization-initiating function was 40 mol % (m=40, m₁=2m=80).

Similarly, a UV2A mode cell including the polyamic acid vertical alignment film of Example 20 was produced using the polyamic acid prepared in Example 5, in which the introduction amount of the thioxanthone and dimethylamino functional group having a radical polymerization-initiating function was 50 mol % (m=50, m₁=2m=100).

Similarly, a UV2A mode cell including the polyamic acid vertical alignment film of Comparative Example 4 was produced using the polyamic acid prepared in Comparative Example 1, in which the introduction amount of the thioxanthone and dimethylamino functional group having a radical polymerization-initiating function was 0 mol % (m=0, m₁=2m=0).

The liquid crystal cells (UV2A mode cells) including the polyamic acid vertical alignment films of Examples 16 to 20 and Comparative Example 4 were evaluated for physical properties by the following methods.

The produced UV2A mode cell was sandwiched by polarizing plates and was energized with backlight for 100 hours. The energization was performed at 10 V and 30 Hz. After the energization with backlight, the VHR, the residual DC (rDC), and the amount of change in the tilt angle (Δtilt) were measured. The VHR was measured at 1 V (70° C.) with a VHR measurement system, model 6254, manufactured by TOYO Corporation. In the measurement of rDC, the DC offset voltage was set to 2 V, and the rDC after voltage application for 2 hours was determined by a flicker elimination method. In the measurement of the amount of change in the tilt angle (Δtilt), the difference between the pretilt angles before and after energization with an AC voltage of 7.5 V was determined as the amount of change. Contrast (CR) was determined with BM-5AS manufactured by TOPCOM Technology Co., Ltd. at a measurement temperature of 25° C. within a measurement wavelength range of 380 to 780 nm. The residual monomer was determined by gas chromatography (GC) based on the ratio between the initial monomer peak and the monomer peak after fluorescent lamp irradiation.

The VHR means the rate of charge to be held. It can be judged that a liquid crystal display device having a higher VHR is a higher quality product. In addition, it can be judged that a liquid crystal display device having a smaller rDC is a higher quality product.

It can be judged that a liquid crystal display device having a smaller amount of change in pretilt angle is a higher quality product.

The results of evaluation are shown in Table 1-1.

As shown in Table 1-1, the results were that in the liquid crystal display device of Comparative Example 4, the residual monomer amount by fluorescent lamp irradiation for 20 minutes was large, 26%, and the VHR, rDC, Δtilt, and CR were all low.

On the other hand, in the liquid crystal display devices of Examples 16 to 20 using a polymer compound having a covalently bonded functional group represented by Formula (1) having a radical polymerization-initiating function, the VHR, rDC, Δtilt, and CR were all improved.

In addition, in the liquid crystal cells (UV2A mode cells) including the polyamic acid vertical alignment films of Examples 16 to 20, the VHR, rDC, Δtilt, and CR were all improved with an increase in the introduction amount of the thioxanthone functional group represented by Formula (1) having a radical polymerization-initiating function. In addition, since the residual monomer was decreased to below the detection limit of GC when m≥30 and m₁=2m≥60, it was assumed that a polymer having a huge size was not formed and that an alignment-sustaining layer 40 made of a homogeneous polymer was able to be formed on the surface of the alignment film 12 with uniform adhesion.

TABLE 1

| | Comparative | | | | | |
|---|---|---|---|---|---|---|
| | Example 4 | Example 16 | Example 17 | Example 18 | Example 19 | Example 20 |
| | (m = 0) | (m = 10) | (m = 20) | (m = 30) | (m = 40) | (m = 50) |
| Introduction amount (mol %) | m₁ = 0 | m₁ = 20 | m₁ = 40 | m₁ = 60 | m₁ = 80 | m₁ = 100 |
| of functional group having | | | | | | |
| polymerization-initiating | | | | | | |
| function | | | | | | |
| VHR (%) | 98.1 | 99.2 | 99.3 | 99.3 | 99.3 | 99.3 |
| rDC (mV) | 90 | 30 | 20 | 0 | 0 | 0 |
| Δtilt (°) | 0.09 | 0.03 | 0.03 | 0.03 | 0.03 | 0.03 |
| Contrast (CR) | 1000 | 4500 | 4900 | 5000 | 5100 | 5200 |
| Residual monomer rate (%) | 26 | 5 | 0.5 | 0.1 or less (below | 0.1 or less (below | 0.1 or less (below |
| | | | | detection limit) | detection limit) | detection limit) |

| | Comparative | | | | | |
|---|---|---|---|---|---|---|
| | Example 5 | Example 21 | Example 22 | Example 23 | Example 24 | Example 25 |
| | (m = 0) | (m = 5) | (m = 10) | (m = 15) | (m = 20) | (m = 25) |
| Introduction amount (mol %) | m₁ = 0 | m₁ = 10 | m₁ = 20 | m₁ = 30 | m₁ = 40 | m₁ = 50 |
| of functional group having | | | | | | |
| polymerization-initiating | | | | | | |
| function | | | | | | |
| VHR (%) | 97 | 99.3 | 99.5 | 99.5 | 99.5 | 99.6 |
| rDC (mV) | 110 | 40 | 10 | 0 | 0 | 0 |
| Bend stability (occurrence of | Returned to splay | Partially returned to | Not returned to | Not returned to | Not returned to | Not returned to |
| returning to splay alignment | alignment within | splay alignment | splay alignment | splay alignment | splay alignment | splay alignment |
| from bend alignment) | 24 h | after 24 h | | | | |
| Residual monomer rate (%) | 20 | 2 | 0.1 or less (below | 0.1 or less (below | 0.1 or less (below | 0.1 or less (below |
| | | | detection limit) | detection limit) | detection limit) | detection limit) |

### Examples 21 to 25 and Comparative Example 5

### (Process of Producing Liquid Crystal Cell)

As active matrix substrates, a TFT substrate having a display region of 10 inches and a thickness of 0.7 mm and a color filter substrate including a color filter were prepared. A solution of the polyamic acid prepared in Example 11, in which the introduction amount of the thioxanthone and dimethylamino functional group having a radical polymerization-initiating function was 10 mol % (m=5, m₁=2m=10) and the main chain includes a photoreactive azobenzene group, was applied onto the surface of the TFT substrate. After pre-baking at 80° C., past-baking by heating at 200° C. was performed for 60 minutes to form a film having a thickness of 100 nm. As the solvent, a mixture solvent of N-methylpyrrolidone (NMP) and y-butyrolactone was used at a mass ratio of 1:1.

Subsequently, through a cut filter cutting wavelengths of 400 nm or more, linearly polarized ultraviolet light irradiation from a direction of 400 oblique to the substrate was performed for alignment treatment to achieve splay alignment when the substrates are bonded. Since a polyamic acid having a main chain including a photoreactive azobenzene group is used as the forming material, the resulting alignment film functions as a polyamic acid horizontal alignment film.

A seal was then applied to the TFT substrate having the polyamic acid horizontal alignment film, beads were dispersed onto the color filter substrate, the substrates were then adhered to each other, and a liquid crystal material (Tni: 85° C., Δε: 8.5) showing positive dielectric anisotropy was injected therebetween. The liquid crystal material contained 0.30 mass % of a difunctional monomer represented by the following Formula (30).

After injection of the liquid crystal material, the liquid crystal material was heated up to 130° C., which is a temperature higher than the nematic phase transition temperature (Tni) of the liquid crystal material, and was rapidly cooled. Subsequently, a high voltage (8 V) was applied to the resulting cell to achieve bend alignment, and the application voltage was then decreased to 2 V while not breaking the bend alignment. Subsequently, the cell was irradiated with light (using a fluorescent lamp) of 400 nm or more through a filter cutting 400 nm or less for 15 minutes to polymerize the monomer. Thus, an OCB mode (bend alignment) cell including the polyamic acid horizontal alignment film of Example 21 was produced.

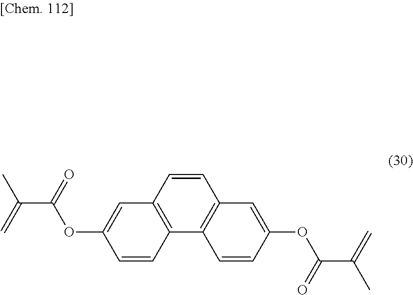 [SMILES: C=C(C)C(=O)Oc1ccc2c(ccc3cc(OC(=O)C(=C)C)ccc32)c1]

Similarly, an OCB mode (bend alignment) cell including the polyamic acid horizontal alignment film of Example 22 was produced using the polyamic acid prepared in Example 12 having a main chain including a photoreactive azobenzene group, in which the introduction amount of the thioxanthone and dimethylamino functional group having a radical polymerization-initiating function was 20 mol % (m=10, m₁=2m=20).

Similarly, an OCB mode (bend alignment) cell including the polyamic acid horizontal alignment film of Example 23 was produced using the polyamic acid prepared in Example 13 having a main chain including a photoreactive azobenzene group, in which the introduction amount of the thioxanthone and dimethylamino functional group having a radical polymerization-initiating function was 30 mol % (m=15, m₁=2m=30).

Similarly, an OCB mode (bend alignment) cell including the polyamic acid horizontal alignment film of Example 24 was produced using the polyamic acid prepared in Example 14 having a main chain including a photoreactive azobenzene group, in which the introduction amount of the thioxanthone and dimethylamino functional group having a radical polymerization-initiating function was 40 mol % (m=20, m₁=2m=40).

Similarly, an OCB mode (bend alignment) cell including the polyamic acid horizontal alignment film of Example 25 was produced using the polyamic acid prepared in Example 15 having a main chain including a photoreactive azobenzene group, in which the introduction amount of the thioxanthone and dimethylamino functional group having a radical polymerization-initiating function was 50 mol % (m=25, m₁=2m=50).

Similarly, an OCB mode (bend alignment) cell including the polyamic acid horizontal alignment film of Comparative Example 5 was produced using the polyamic acid prepared in Comparative Example 3 having a main chain including a photoreactive azobenzene group, in which the introduction amount of the thioxanthone and dimethylamino functional group having a radical polymerization-initiating function was 0 mol % (m=0, m₁=2m=0).

The liquid crystal cells (OCB mode (bend alignment)) of Examples 21 to 25 and Comparative Example 5 were evaluated for physical properties by the following methods.

The produced bend alignment cells were left to stand at room temperature for 24 hours, and whether bend alignment returned to splay alignment or not was verified. Subsequently, each cell was sandwiched by polarizing plates and was energized with backlight for 100 hours. The energization was performed at 10 V and 30 Hz. After the energization with backlight, the VHR and the rDC were measured. The VHR was measured at 1 V (70° C.). In the measurement of rDC, the DC offset voltage was set to 2 V, and the rDC was determined by a flicker elimination method. The residual monomer was determined by gas chromatography (GC) based on the ratio between the initial monomer peak and the monomer peak after fluorescent lamp irradiation. Regarding the alignment, the alignment state (bend alignment or splay alignment) was verified using a polarizing microscope.

The results of evaluation are shown in Table 1-2. As shown in Table 1-2, the results were that in the liquid crystal display device of Comparative Example 5, the residual monomer amount by fluorescent lamp irradiation for 15 minutes was large, 20%, and the VHR, rDC, and bend stability were all low.

On the other hand, in the liquid crystal display devices of Examples 21 to 25 using a polymer compound having a covalently bonded functional group represented by Formula (1) having a radical polymerization-initiating function, the VHR, rDC, and bend stability were all improved.

In addition, also in the liquid crystal cells (OCB mode (bend alignment) cells) of Examples 21 to 25 including the polyamic acid horizontal alignment films, the VHR, rDC, and bend stability were all improved with an increase in the introduction amount of the thioxanthone functional group represented by Formula (1) having a radical polymerization-initiating function.

In addition, since the residual monomer was decreased to below the detection limit of GC when m 10 and m₁=2m 20, it was assumed that a polymer having a huge size was not formed and that an alignment-sustaining layer 40 made of a homogeneous polymer was able to be formed on the surface of the alignment film 12 with uniform adhesion.

In the liquid crystal cell including a polyamic acid horizontal alignment film, if the introduction amount of the functional group having a radical polymerization-initiating function is large, there is a risk that the pretilt angle will become too large. Accordingly, in a polyamic acid horizontal alignment film, the introduction amount (m₁) of a functional group having a radical polymerization-initiating function is preferably 60 mol % or less or 50 mol % or less and may be 40 mol % or less or 30 mol % or less.

### INDUSTRIAL APPLICABILITY

Some aspects of the present invention can be applied, for example, to a liquid crystal display device that includes an alignment-sustaining layer controlling the pretilt direction of liquid crystal molecules and an alignment film and is required to have excellent image quality by suppressing a decrease in VHR and an increase in residual DC, improving the amount of change in pretilt angle, and suppressing a decrease in contrast, and to an alignment film and a polymer compound.

### REFERENCE SIGNS LIST

10 element substrate
11 one substrate
12 alignment film
20 counter substrate
21 color filter substrate
22 second alignment film
30 liquid crystal layer
40 alignment-sustaining layer
50 second alignment-sustaining layer
100 liquid crystal display device

1. A liquid crystal display device comprising a pair of substrates, a liquid crystal layer sandwiched between the pair of substrates, an alignment film disposed between the liquid crystal layer and at least one substrate of the pair of substrates, and an alignment-sustaining layer provided between the alignment film and the liquid crystal layer and regulating the tilt direction of at least liquid crystal molecules close to the alignment film among liquid crystal molecules constituting the liquid crystal layer, wherein the alignment film contains a polymer compound having a functional group represented by the following Formula (1):

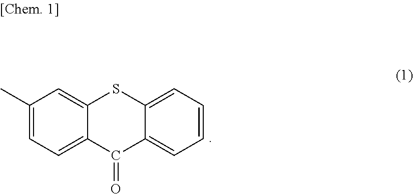 [SMILES: Cc1ccc2c(=O)c3ccccc3sc2c1]

2. The liquid crystal display device according to claim 1, wherein the polymer compound has a functional compound represented by the following Formula (2):

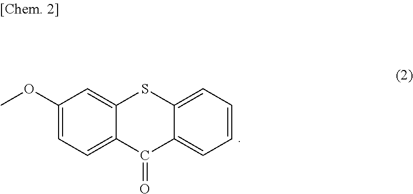 [SMILES: COc1ccc2c(=O)c3ccccc3sc2c1]

3. The liquid crystal display device according to claim 2, wherein the polymer compound has a divalent functional group represented by the following Formula (3): 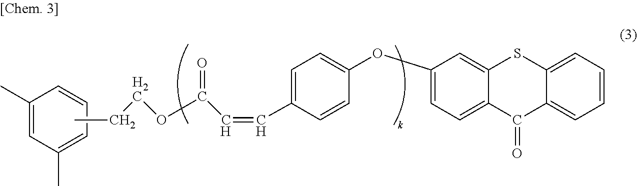
(k represents an integer of 0 to 3).

4. The liquid crystal display device according to claim 3, wherein the polymer compound has a divalent functional group represented by the following Formula (4):

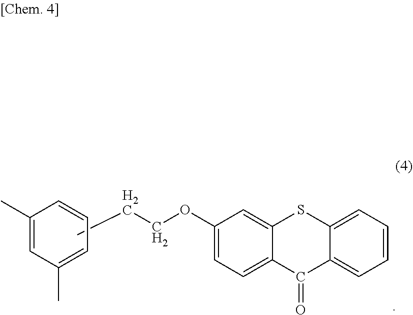

5. The liquid crystal display device according to claim 1, wherein the alignment film contains a polymer compound having a functional group represented by the following (5): 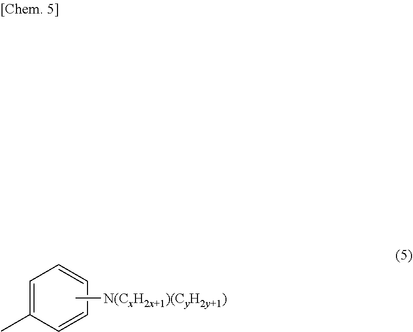
(x represents an integer of 1 to 4, and y represents an integer of 1 to 4).

6. The liquid crystal display device according to claim 1, wherein the alignment film is made of a polyimide, a polyamic acid, or a polysiloxane.

7. The liquid crystal display device according to claim 1, wherein the alignment film contains a polymer compound having a photoreactive functional group.

8. The liquid crystal display device according to claim 7, wherein the photoreactive functional group is a group having a cinnamate group, a chalcone group, a coumarin group, an azobenzene group, or a tolan group.

9. The liquid crystal display device according to claim 1, wherein the alignment film is made of a polyamic acid having a structural unit represented by the following Formula (6) or a polyimide having a structural unit represented by the following Formula (7): 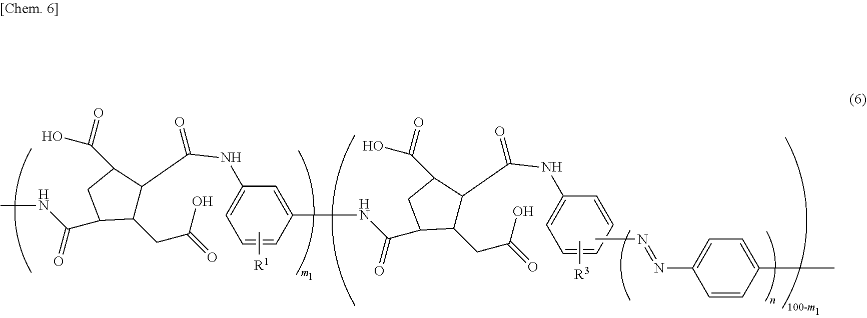
(m1 and (100−m1) represent copolymerization rates (mol %) of the respective structural units, where m1 is higher than 0 and not higher than 100; n represents 0 or 1; R1 represents a functional group represented by the following Formula (8), where a part of the functional group represented by Formula (8) is optionally substituted with a functional group represented by the following Formula (9); and R3 represents a photoreactive functional group, a vertically aligning group, or a horizontally aligning group), 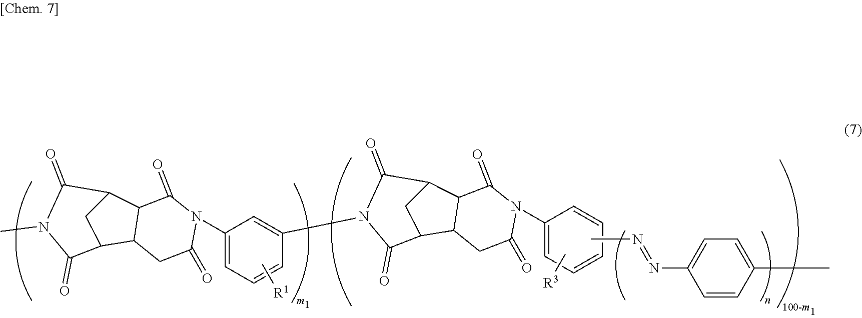
(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group), 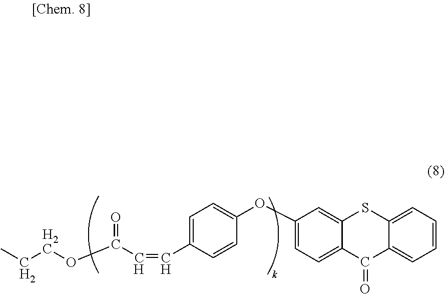
(k represents an integer of 0 to 3), 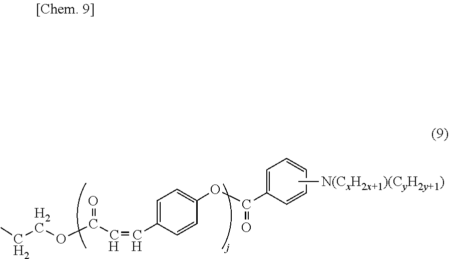
(j represents an integer of 0 to 3, x represents an integer of 1 to 4, and y represents an integer of 1 to 4).

10. The liquid crystal display device according to claim 1, wherein the alignment-sustaining layer is formed by radical polymerizations of a radical polymerizable monomer.

11. A alignment film-forming material comprising a polymer compound having a functional group represented by the following Formula (1):

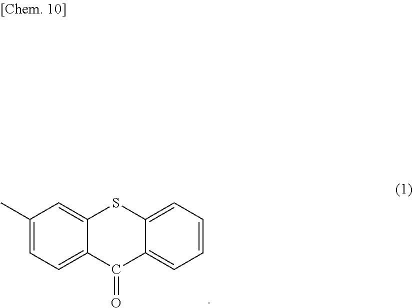 [SMILES: Cc1ccc2c(=O)c3ccccc3sc2c1]

12. A polyamic acid having a structural unit represented by the following Formula (6): 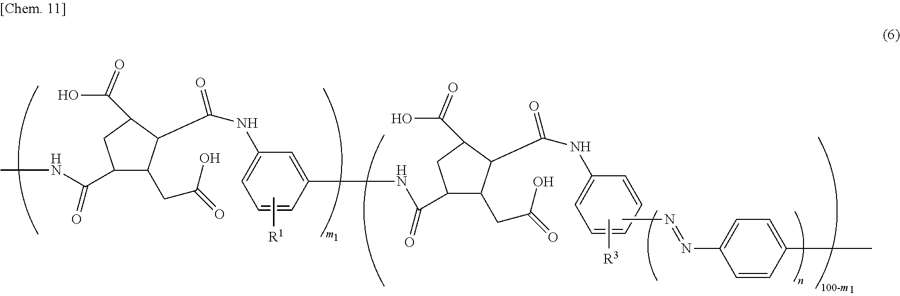
(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group), 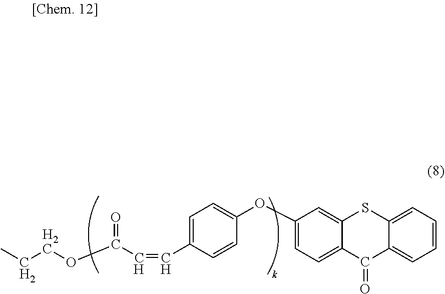
(k represents an integer of 0 to 3), 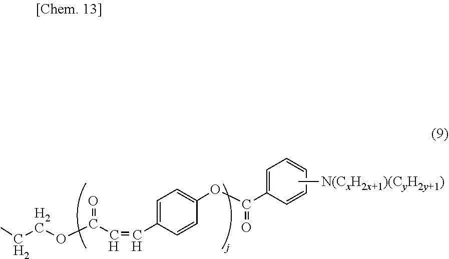
(j represents an integer of 0 to 3, x represents an integer of 1 to 4, and y represents an integer of 1 to 4).

13. A polyimide having a structural unit represented by the following Formula (7): 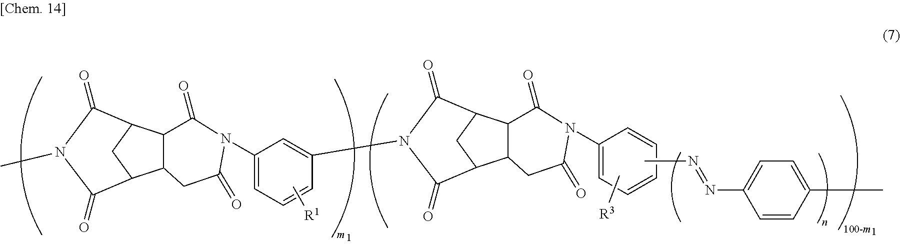
(m₁ and (100−m₁) represent copolymerization rates (mol %) of the respective structural units, where m₁ is higher than 0 and not higher than 100; n represents 0 or 1; R¹ represents a functional group represented by the following Formula (8), where a part of the functional group represented by Formula (8) is optionally substituted with a functional group represented by the following Formula (9); and R³ represents a photoreactive functional group, a vertically aligning group, or a horizontally aligning group), 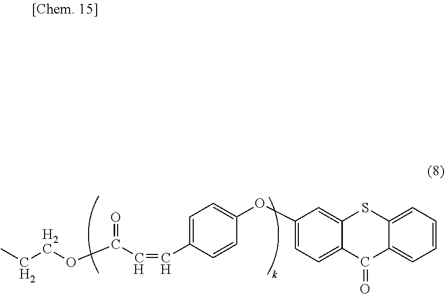
(k represents an integer of 0 to 3), 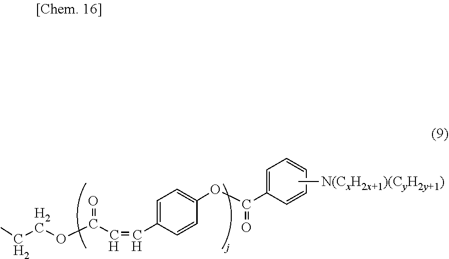
(j represents an integer of 0 to 3, x represents an integer of 1 to 4, and y represents an integer of 1 to 4).
